(19) United States
(12) Patent Application Publication
(10) Pub. No.: US 2024/0107523 A1
(43) Pub. Date: Mar. 28, 2024

(54) ANTENNA PORT INDICATION FOR MORE THAN FOUR LAYER PHYSICAL UPLINK SHARED CHANNEL OPERATION

(71) Applicant: Apple Inc., Cupertino, CA (US)

(72) Inventors: Haitong Sun, Cupertino, CA (US); Ankit Bhamri, Bad Nauheim (DE); Chunxuan Ye, San Diego, CA (US); Dawei Zhang, Saratoga, CA (US); Hong He, San Jose, CA (US); Oghenekome Oteri, San Diego, CA (US); Wei Zeng, Saratoga, CA (US); Xiang Chen, Campbell, CA (US)

(21) Appl. No.: 18/453,661

(22) Filed: Aug. 22, 2023

Related U.S. Application Data
(60) Provisional application No. 63/409,160, filed on Sep. 22, 2022.

(51) Int. Cl. H04W 72/1268; H04L 5/00; H04W 72/231; H04W 76/20

(52) U.S. Cl. CPC H04W 72/1268; H04L 5/0051; H04W 72/231; H04W 76/20

(57) ABSTRACT

The present application relates to devices and components including apparatus, systems, and methods to provide antenna port indication for more than four layer physical uplink shared channel operation.

### CROSS-REFERENCE TO RELATED APPLICATIONS

This application claims priority to U.S. provisional application No. 63/409,160, entitled “Antenna Port Indication for more than Four Layer Physical Uplink Shared Channel Operation,” filed on Sep. 22, 2022, the disclosure of which is incorporated by reference herein in its entirety for all purposes.

### TECHNICAL FIELD

The present application relates to the field of wireless technologies and, in particular, to antenna ports for more than four layer physical uplink shared channel (PUSCH) operation.

### BACKGROUND

Third Generation Partnership Project (3GPP) networks can make use of multiple antenna ports to transmit communications between a base station and a user equipment (UE). The network, via the base station, indicates antenna ports to be utilized for transmissions. The UE determines the antenna ports that can be utilized for a transmission and transmits the transmission via the antenna ports indicated by the network.

### BRIEF DESCRIPTION OF THE DRAWINGS

FIG. 1 illustrates an example demodulation reference signal (DMRS) port mapping for cyclic prefix orthogonal frequency division multiplexing (CP-OFDM) in accordance with some embodiments.

FIG. 2 illustrates an example DMRS port mapping for CP-OFDM in accordance with some embodiments.

FIG. 3 illustrates an example table for approach 1.2 in accordance with some embodiments.

FIG. 4 illustrates an example table for approach 1.3 in accordance with some embodiments.

FIG. 5 illustrates an example table for approach 1.4 in accordance with some embodiments.

FIG. 6 illustrates an example table for approach 1.5 in accordance with some embodiments.

FIG. 7 illustrates an example table for approach 2.2 in accordance with some embodiments.

FIG. 8 illustrates an example table for approach 2.3 in accordance with some embodiments.

FIG. 9 illustrates an example table for approach 3.2 in accordance with some embodiments.

FIG. 10 illustrates an example table for approach 3.3 in accordance with some embodiments.

FIG. 11 illustrates an example table for approach 3.5 in accordance with some embodiments.

FIG. 12 illustrates an example table for approach 3.6 in accordance with some embodiments.

FIG. 13 illustrates an example signaling chart that can implement at least a portion of the one or more approaches in accordance with some embodiments.

FIG. 14 illustrates an example signaling chart that can implement at least a portion of the one or more approaches in accordance with some embodiments.

FIG. 15 illustrates a multiple user-multiple input, multiple output (MU-MIMO) arrangement in accordance with some embodiments.

FIG. 16 illustrates an example procedure for operating a user equipment (UE) in accordance with some embodiments.

FIG. 17 illustrates an example procedure for operating a UE in accordance with some embodiments.

FIG. 18 illustrates an example procedure for operating a base station in accordance with some embodiments.

FIG. 19 illustrates an example UE in accordance with some embodiments.

FIG. 20 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services.

The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Issue Statement

In legacy new radio (NR), for physical uplink shared channel (PUSCH) operation, we have two operation mode. nonCodebook, i.e., txConfig=nonCodebook, the number of layers and precoding is indicated by the “sounding reference signal (SRS) resource indicator” field. codebook, i.e., txConfig=codebook, the number of layers and precoding is indicated by the “Precoding information and number of layers” field, in Downlink Control Information (DCI) Format 0_1/0_2 scheduling PUSCH. For example, legacy systems may operate in nonCodebook and codebook operation modes for transmissions. In nonCodebook operation, the network may indicate the number of layers and precoding to a user equipment (UE) via the SRS resource indicator field. In codebook operation, the network may indicate the number of layers and precoding to a UE via a precoding information and number of layers field.

For PUSCH operation, after network (NW) indicates the number of layer and precoding to the user equipment (UE), NW also needs to indicate to the UE which antenna port(s) are used for demodulation reference signal (DMRS) transmission, in third generation partnership project (3GPP) technical specification (TS) 38.212 (3GPP Organizational Partners, “3rd Generation Partnership Project; Technical Specification Group Radio Access Network; NR; Multiplexing and channel coding (Release 17),” TS 38.212 V17.2.0, June 2022) for cyclic prefix orthogonal frequency division multiplexing (CP-OFDM). Tables 7.3.1.1.2-8/9/10/11 of TS 38.212 is used for DMRS configuration Type 1 and maximum 1 DMRS symbols per DMRS location. Tables 7.3.1.1.2-12/13/14/15 of TS 38.212 is used for DMRS configuration Type 1 and maximum 2 DMRS symbols per DMRS location. Tables 7.3.1.1.2-16/17/18/19 of TS 38.212 is used for DMRS configuration Type 2 and maximum 1 DMRS symbols per DMRS location. Tables 7.3.1.1.2-20/21/22/23 of TS 38.212 is used for DMRS configuration Type 2 and maximum 2 DMRS symbols per DMRS location.

Up to now, new radio (NR) supports up to 4 layer PUSCH operation. For example, UL transmissions transmitted via the PUSCH were limited to a maximum of four layers. Accordingly, the UL transmissions may be transmitted via a maximum of four antenna ports based on the UL transmissions being limited to the maximum of four layers.

In release 18 (Rel-18) NR, in the approved Work Item Description (WID), i.e., RP-213598, it was agreed to specify two things. DMRS enhancement to support double amount of DMRS ports for CP-OFDM. More than 4 layer PUSCH operation.

Study, and if justified, specify larger number of orthogonal DMRS ports for downlink and uplink multiple user-multiple input, multiple output (MU-MIMO) (without increasing the demodulation reference signal (DM-RS) overhead), only for CP-OFDM. Striving for a common design between downlink (DL) and uplink (UL) DMRS. Up to 24 orthogonal DM-RS ports, where for each applicable DMRS type, the maximum number of orthogonal ports is doubled for both single- and double-symbol DMRS.

Study, and if justified, specify UL DMRS, SRS, SRS resource indicator (SRI), and transmitted precoding matrix indicator (TPMI) (including codebook) enhancements to enable 8 transmission (Tx) UL operation to support 4 and more layers per UE in UL targeting customer premise equipment (CPE)/fixed wireless access (FWA)/vehicle/Industrial devices. Note: Potential restrictions on the scope of this objective (including coherence assumption, full/non-full power modes) will be identified as part of the study.

Approaches described herein provide antenna ports indication enhancement to support more than 4 layer PUSCH operation: Legacy DMRS, dmrs-Type=1, maxLength=2; Legacy DMRS, dmrs-Type=2, maxLength=1; Legacy DMRS, dmrs-Type=2, maxLength=2; General design. For example, the approaches described herein may provide for a NW, via a base station, to indicate, to a UE, antenna ports to be utilized for UL transmissions to be transmitted by the UE.

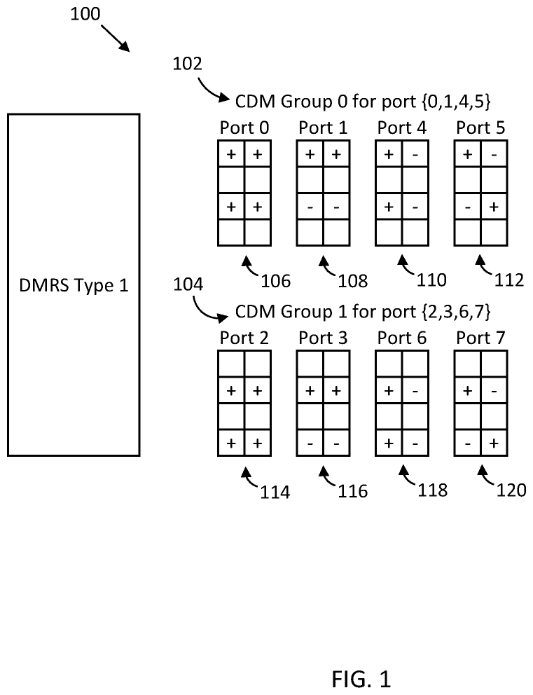

Legacy DMRS port mapping for CP-OFDM in the legacy NR. FIG. 1 illustrates an example DMRS port mapping 100 for CP-OFDM in accordance with some embodiments. For example, the DMRS port mapping 100 illustrates DMRS type 1 port mapping in accordance with some embodiments.

The DMRS port mapping 100 may include a first CDM group 102 (referred to as CDM group 0) and a second CDM group 104 (referred to as CDM group 1). The ports for DMRS type 1 may be separated into the first CDM group 102 and the second CDM group 104.

The ports may be separated into the first CDM group 102 and the second CDM group 104 based on the antenna elements corresponding to the ports.

DMRS type 1 may include eight ports. The eight ports may be divided equally between the first CDM group 102 and the second CDM group 104. In particular, the first CDM group 102 may include a first port 106 (referred to as port 0), a second port 108 (referred to as port 1), a fifth port 110 (referred to as port 4), and a sixth port 112 (referred to as port 5). The second CDM group 104 may include a third port 114 (referred to as port 2), a fourth port 116 (referred to as port 3), a seventh port 118 (referred to as port 6), and an eight port 120 (referred to as port 7). The network, via a base station, may indicate ports of the eight ports to be utilized for a PUSCH uplink transmission for DMRS type 1 operation, as described further throughout this disclosure.

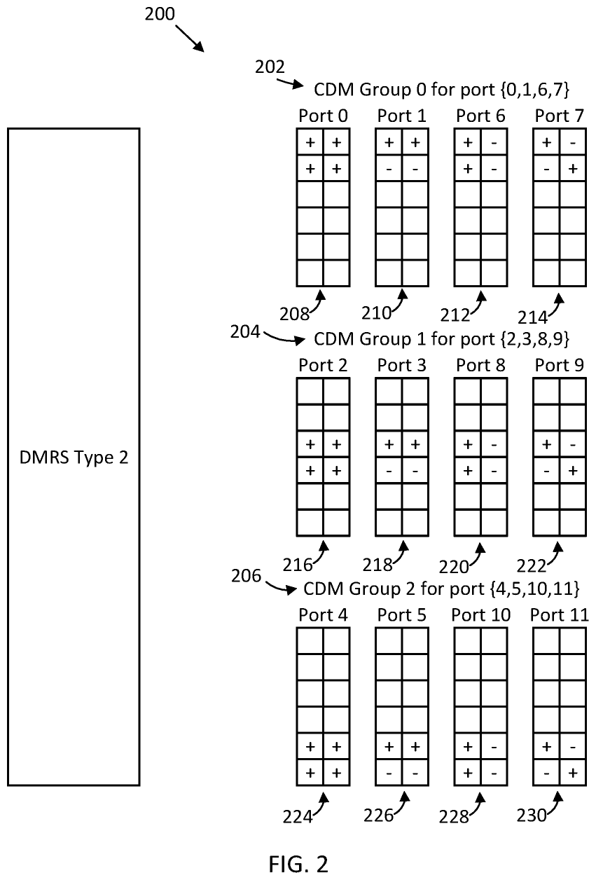

FIG. 2 illustrates an example DMRS port mapping 200 for CP-OFDM in accordance with some embodiments. For example, the DMRS port mapping 200 illustrates DMRS type 2 port mapping in accordance with some embodiments.

The DMRS port mapping 200 may include a first CDM group 202 (referred to as CDM group 0), a second CDM group 204 (referred to as CDM group 1), and a third CDM group 206 (referred to as CDM group 2). The ports for DMRS type 2 may be separated into the first CDM group 202, the second CDM group 204, and the third CDM group 206. The ports may be separated into the first CDM group 202, the second CDM group 204, and the third CDM group 206 based on the antenna elements corresponding to the ports.

DMRS type 2 may include twelve ports. The twelve ports may be divided equally among the first CDM group 202, the second CDM group 204, and the third CDM group 206. In particular, the first CDM group 202 may include a first port 208 (referred to as port 0), a second port 210 (referred to as port 1), a seventh port 212 (referred to as port 6), and an eighth port 214 (referred to as port 7). The second CDM group 204 may include a third port 216 (referred to as port 2), a fourth port 218 (referred to as port 3), a ninth port 220 (referred to as port 8), and a tenth port 222 (referred to as port 9). The third CDM group 206 may include a fifth port 224 (referred to as port 4), a sixth port 226 (referred to as port 5), an eleventh port 228 (referred to as port 10), and a twelfth port 230 (referred to as port 11). The network, via a base station, may indicate ports of the eight ports to be utilized for a PUSCH uplink transmission for DMRS type 2 operation, as described further throughout this disclosure.

Antenna ports table should depend on the following factors. Legacy DMRS or enhanced DMRS: Legacy DMRS; Enhanced DMRS: double the amount of DMRS ports. DMRS configuration Type: Configuration Type 1: dmrs-Type=1; Configuration Type 2: dmrs-Type=2. Maximum number of DMRS symbols per DMRS location: maxLength=1; maxLength=2. The rank, i.e., number of layers, of the scheduling PUSCH: Rank=1/2/3/4/5/6/7/8. For example, the antenna ports to be utilized for a PUSCH transmission may be determined based on whether legacy or enhanced DMRS are being utilized, based on the DMRS configuration type associated with the PUSCH transmission, based on a maximum number of DMRS symbols per DMRS location, based on a rank of the scheduling PUSCH, or some combination thereof. In the enhanced DMRS, the DMRS may have double the amount of DMRS ports of the legacy DMRS. The DMRS configuration type may be configuration type 1 or configuration type 2. The maximum number of DMRS symbols per DMRS location may be one or two. The rank may be the number of layers of the scheduling PUSCH and may have values of 1, 2, 3, 4, 5, 6, 7, or 8. An antenna port table may be utilized to indicate the antenna ports to be utilized.

Approach 1: Legacy DMRS, dmrs-Type=1, maxLength=2

Approach 1.1: For legacy DMRS, DMRS configuration Type 1 (dmrs-Type=1) and maximum 2 symbols per DMRS location, to support more than 4 layer PUSCH. For example, an approach 1.1 may be directed to DMRS configuration type 1 with a maximum of two symbols per DMRS location. The indicated number of front-load symbols has to be 2. The indicated Number of DMRS CDM group(s) without data has to be 2. For the DMRS configuration type 2 with a maximum two symbols per DMRS location, the indicated number of DMRS CDM groups without data may be two or three and the indicated number of front-load symbols may be two to support more than four layer PUSCH.

Approach 1.2: For legacy DMRS, DMRS configuration Type 1 (dmrs-Type=1) and maximum 2 symbols per DMRS location, for rank=5, one or multiple of the rows of the following table can be considered. For example, approach 1.2 may be for DMRS configuration type 1 with a maximum of two symbols per DMRS location and a rank of five for a PUSCH transmission.

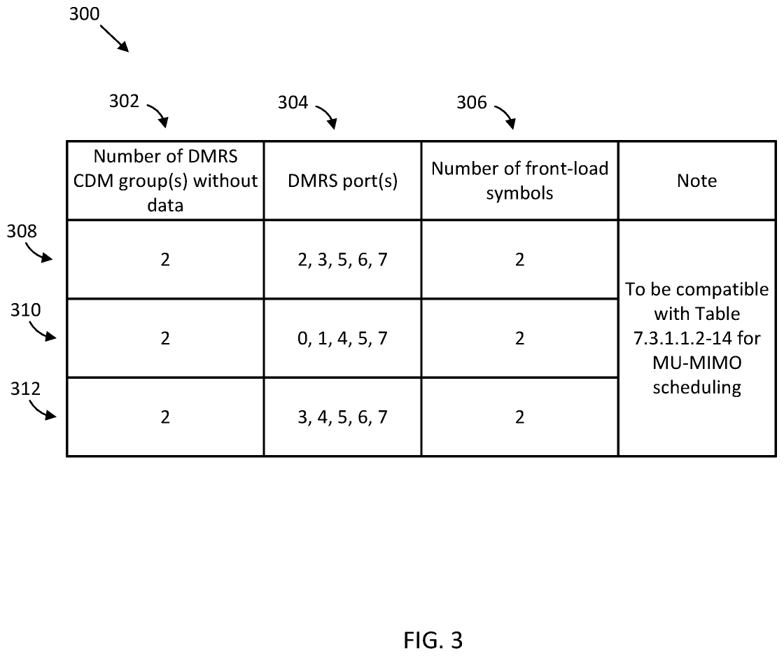

FIG. 3 illustrates an example table 300 for approach 1.2 in accordance with some embodiments. For example, the table 300 may indicate antenna ports (which may be referred to as DMRS ports) that can be used for DMRS configuration type 1 PUSCH transmissions with a maximum of two symbols per DMRS location and a rank of five. The table 300 may be utilized to indicate antenna ports to be utilized for a PUSCH transmission to be transmitted by a UE. The table 300 may be stored by a base station and/or a UE and indications may be exchanged between the base station and the UE that refers to the table 300.

The table 300 may include three options for antenna ports to be utilized for PUSCH transmissions. The options may be defined based on a number of DMRS CDM groups without data 302, antenna ports 304 to be available for transmission, and number of front-load symbols 306.

As can be seen from the table 300, a first option 308 may be for PUSCH transmissions with a number of DMRS CDM groups without data 302 equal to two and a number of front-load symbols 306 equal to two. The available antenna ports 304 for the first option 308 may be port 2, port 3, port 5, port 6, and port 7. Accordingly, a base station may indicate that a UE is to utilize port 2, port 3, port 5, port 6, and port 7 for a PUSCH transmission by indicating the first option 308 of the table 300.

A second option 310 may be for PUSCH transmissions with a number of DMRS CDM groups without data 302 equal to two and a number of front-load symbols 306 equal to two. The available antenna ports 304 for the second option 310 may be port 0, port 1, port 4, port 5, and port 7. Accordingly, a base station may indicate that a UE is to utilize port 0, port 1, port 4, port 5, and port 7 for a PUSCH transmission by indicating the second option 310 of the table 300.

A third option 312 may be for PUSCH transmissions with a number of DMRS CDM groups without data 302 equal to two and a number of front-load symbols 306 equal to two. The available antenna ports 304 for the third option 312 may be port 3, port 4, port 5, port 6, and port 7. Accordingly, a base station may indicate that a UE is to utilize port 3, port 4, port 5, port 6, and port 7 for a PUSCH transmission by indicating the third option 312 of the table 300.

The options shown in the table 300 may be compatible with options in a legacy table corresponding to a rank of three. For example, the options in the table 300 may indicate different antenna ports for transmission than corresponding options in the legacy table corresponding to a rank of three. Therefore, in MU-MIMO, a base station may indicate antenna ports to be utilized by a first UE using the table 300 and indicate antenna ports to be utilized by a second UE using the legacy table corresponding to a rank of three, where the antenna ports to be utilized by the first UE is different from the antenna ports to be utilized by the second UE. Based on the indications, the first UE and the second UE may transmit PUSCH transmissions using different antenna ports. The options in the table 300 may be compatible with legacy table 7.3.1.1.2-14 of TS 38.212 for MU-MEVIO scheduling.

Approach 1.3: For legacy DMRS, DMRS configuration Type 1 (dmrs-Type=1) and maximum 2 symbols per DMRS location, for rank=6, one or multiple of the rows of the following table can be considered. For example, approach 1.3 may be for DMRS configuration type 1 with a maximum of two symbols per DMRS location and a rank of six for a PUSCH transmission.

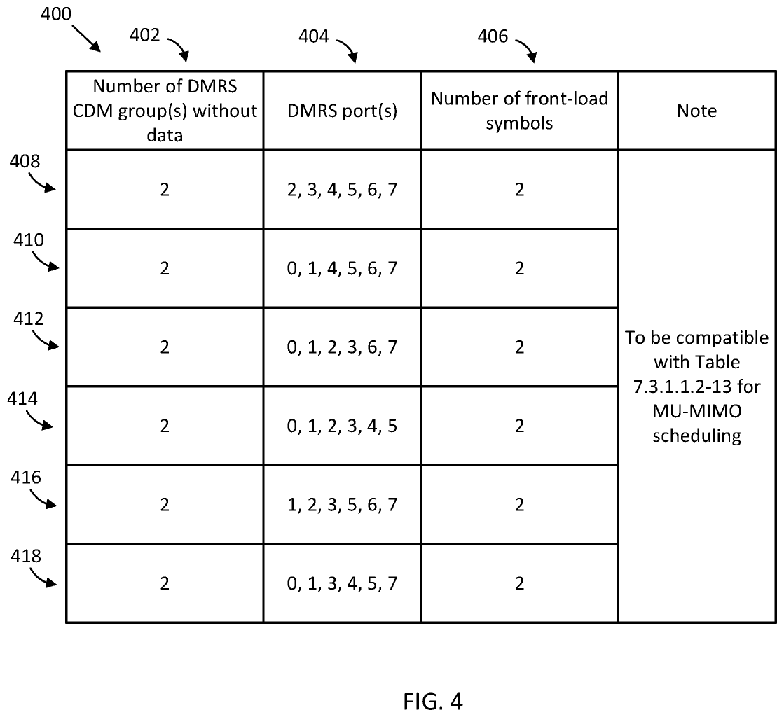

FIG. 4 illustrates an example table 400 for approach 1.3 in accordance with some embodiments. For example, the table 400 may indicate antenna ports (which may be referred to as DMRS ports) that can be used for DMRS configuration type 1 PUSCH transmissions with a maximum of two symbols per DMRS location and a rank of six. The table 400 may be utilized to indicate antenna ports to be utilized for a PUSCH transmission to be transmitted by a UE. The table 400 may be stored by a base station and/or a UE and indications may be exchanged between the base station and the UE that refers to the table 400.

The table 400 may include six options for antenna ports to be utilized for PUSCH transmissions. The options may be defined based on a number of DMRS CDM groups without data 402, antenna ports 404 to be available for transmission, and number of front-load symbols 406.

As can be seen from the table 400, a first option 408 may be for PUSCH transmissions with a number of DMRS CDM groups without data 402 equal to two and a number of front-load symbols 406 equal to two. The available antenna ports 404 for the first option 408 may be port 2, port 3, port 4, port 5, port 6, and port 7. Accordingly, a base station may indicate that a UE is to utilize port 2, port 3, port 4, port 5, port 6, and port 7 for a PUSCH transmission by indicating the first option 408 of the table 400.

A second option 410 may be for PUSCH transmissions with a number of DMRS CDM groups without data 402 equal to two and a number of front-load symbols 406 equal to two. The available antenna ports 404 for the second option 410 may be port 0, port 1, port 4, port 5, port 6, and port 7. Accordingly, a base station may indicate that a UE is to utilize port 0, port 1, port 4, port 5, port 6, and port 7 for a PUSCH transmission by indicating the second option 410 of the table 400.

A third option 412 may be for PUSCH transmissions with a number of DMRS CDM groups without data 402 equal to two and a number of front-load symbols 406 equal to two. The available antenna ports 404 for the third option 412 may be port 0, port 1, port 2, port 3, port 6, and port 7. Accordingly, a base station may indicate that a UE is to utilize port 0, port 1, port 2, port 3, port 6, and port 7 for a PUSCH transmission by indicating the third option 412 of the table 400.

A fourth option 414 may be for PUSCH transmissions with a number of DMRS CDM groups without data 402 equal to two and a number of front-load symbols 406 equal to two. The available antenna ports 404 for the fourth option 414 may be port 0, port 1, port 2, port 3, port 4, and port 5. Accordingly, a base station may indicate that a UE is to utilize port 0, port 1, port 2, port 3, port 4, and port 5 for a PUSCH transmission by indicating the fourth option 414 of the table 400.

A fifth option 416 may be for PUSCH transmissions with a number of DMRS CDM groups without data 402 equal to two and a number of front-load symbols 406 equal to two. The available antenna ports 404 for the fifth option 416 may be port 1, port 2, port 3, port 5, port 6, and port 7. Accordingly, a base station may indicate that a UE is to utilize port 1, port 2, port 3, port 5, port 6, and port 7 for a PUSCH transmission by indicating the fifth option 416 of the table 400.

A sixth option 418 may be for PUSCH transmissions with a number of DMRS CDM groups without data 402 equal to two and a number of front-load symbols 406 equal to two. The available antenna ports 404 for the sixth option 418 may be port 0, port 1, port 3, port 4, port 5, and port 7. Accordingly, a base station may indicate that a UE is to utilize port 0, port 1, port 3, port 4, port 5, and port 7 for a PUSCH transmission by indicating the sixth option 418 of the table 400.

The options shown in the table 400 may be compatible with options in a legacy table corresponding to a rank of two. For example, the options in the table 400 may indicate different antenna ports for transmission than corresponding options in the legacy table corresponding to a rank of two. Therefore, in MU-MIMO, a base station may indicate antenna ports to be utilized by a first UE using the table 400 and indicate antenna ports to be utilized by a second UE using the legacy table corresponding to a rank of two, where the antenna ports to be utilized by the first UE is different from the antenna ports to be utilized by the second UE. Based on the indications, the first UE and the second UE may transmit PUSCH transmissions using different antenna ports. The options in the table 400 may be compatible with legacy table 7.3.1.1.2-13 of TS 38.212 for MU-MEVIO scheduling.

Approach 1.4: For legacy DMRS, DMRS configuration Type 1 (dmrs-Type=1) and maximum 2 symbols per DMRS location, for rank=7, one or multiple of the rows of the following table can be considered. For example, approach 1.4 may be for DMRS configuration type 1 with a maximum of two symbols per DMRS location and a rank of seven for a PUSCH transmission.

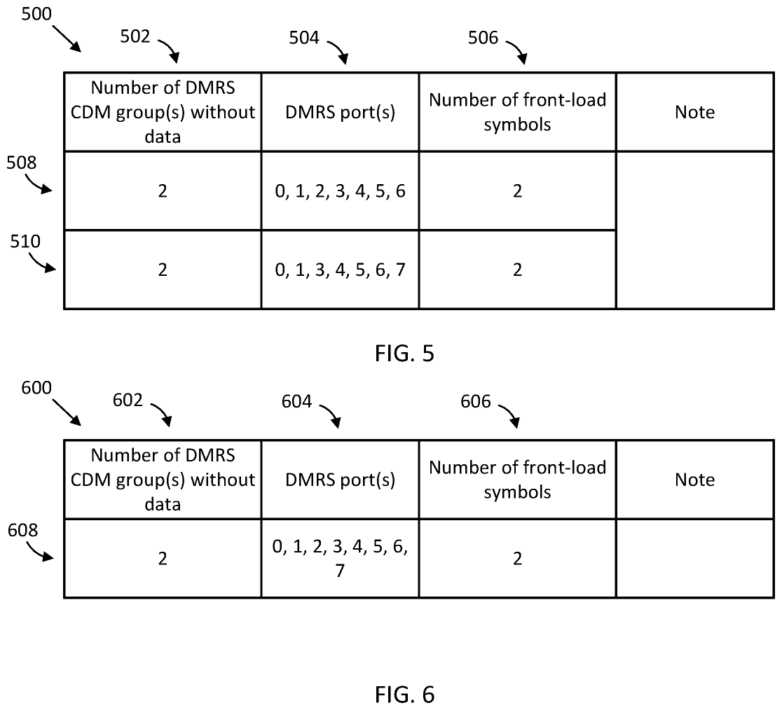

FIG. 5 illustrates an example table 500 for approach 1.4 in accordance with some embodiments. For example, the table 500 may indicate antenna ports (which may be referred to as DMRS ports) that can be used for DMRS configuration type 1 PUSCH transmissions with a maximum of two symbols per DMRS location and a rank of seven. The table 500 may be utilized to indicate antenna ports to be utilized for a PUSCH transmission to be transmitted by a UE. The table 500 may be stored by a base station and/or a UE and indications may be exchanged between the base station and the UE that refers to the table 500.

The table 500 may include two options for antenna ports to be utilized for PUSCH transmissions. The options may be defined based on a number of DMRS CDM groups without data 502, antenna ports 504 to be available for transmission, and number of front-load symbols 506.

As can be seen from the table 500, a first option 508 may be for PUSCH transmissions with a number of DMRS CDM groups without data 502 equal to two and a number of front-load symbols 506 equal to two. The available antenna ports 504 for the first option 508 may be port 0, port 1, port 2, port 3, port 4, port 5, and port 6. Accordingly, a base station may indicate that a UE is to utilize port 0, port 1, port 2, port 3, port 4, port 5, and port 6 for a PUSCH transmission by indicating the first option 508 of the table 500.

A second option 510 may be for PUSCH transmissions with a number of DMRS CDM groups without data 502 equal to two and a number of front-load symbols 506 equal to two. The available antenna ports 504 for the second option 510 may be port 0, port 1, port 3, port 4, port 5, port 6, and port 7. Accordingly, a base station may indicate that a UE is to utilize port 0, port 1, port 3, port 4, port 5, port 6, and port 7 for a PUSCH transmission by indicating the second option 510 of the table 500.

Approach 1.5: For legacy DMRS, DMRS configuration Type 1 (dmrs-Type=1) and maximum 2 symbols per DMRS location, for rank=8, the following table can be considered. For example, approach 1.5 may be for DMRS configuration type 1 with a maximum of two symbols per DMRS location and a rank of eight for a PUSCH transmission.

FIG. 6 illustrates an example table 600 for approach 1.5 in accordance with some embodiments. For example, the table 600 may indicate antenna ports (which may be referred to as DMRS ports) that can be used for DMRS configuration type 1 PUSCH transmissions with a maximum of two symbols per DMRS location and a rank of eight. The table 600 may be utilized to indicate antenna ports to be utilized for a PUSCH transmission to be transmitted by a UE. The table 600 may be stored by a base station and/or a UE and indications may be exchanged between the base station and the UE that refers to the table 600.

The table 600 may include one option for antenna ports to be utilized for PUSCH transmissions. The option may be defined based on a number of DMRS CDM groups without data 602, antenna ports 604 to be available for transmission, and number of front-load symbols 606.

As can be seen from the table 600, the option 608 may be for PUSCH transmissions with a number of DMRS CDM groups without data 602 equal to two and a number of front-load symbols 606 equal to two. The available antenna ports 604 for the option 608 may be port 0, port 1, port 2, port 3, port 4, port 5, port 6, and port 7. Accordingly, a base station may indicate that a UE is to utilize port 0, port 1, port 2, port 3, port 4, port 5, port 6, and port 7 for a PUSCH transmission by indicating the option 608 of the table 600.

Approach 2: Legacy DMRS, dmrs-Type=2, maxLength=1

Approach 2.1: For legacy DMRS, DMRS configuration Type 2 (dmrs-Type=2) and maximum 1 symbol per DMRS location, to support more than 4 layer PUSCH. The indicated number of DMRS CDM group(s) without data has to be 3. For example, the approach 2.1 may apply to DMRS configuration type 2 and a maximum one symbol per DMRS location associated with a PUSCH transmission. For approach 2.1, the indicated number of DMRS CDM groups without data may be three to support more than four layer PUSCH.

Approach 2.2: For legacy DMRS, DMRS configuration Type 2 (dmrs-Type=2) and maximum 1 symbol per DMRS location, for rank=5, the following table can be considered. For example, approach 2.2 may be for DMRS configuration type 2 with a maximum of one symbol per DMRS location and a rank of five for a PUSCH transmission.

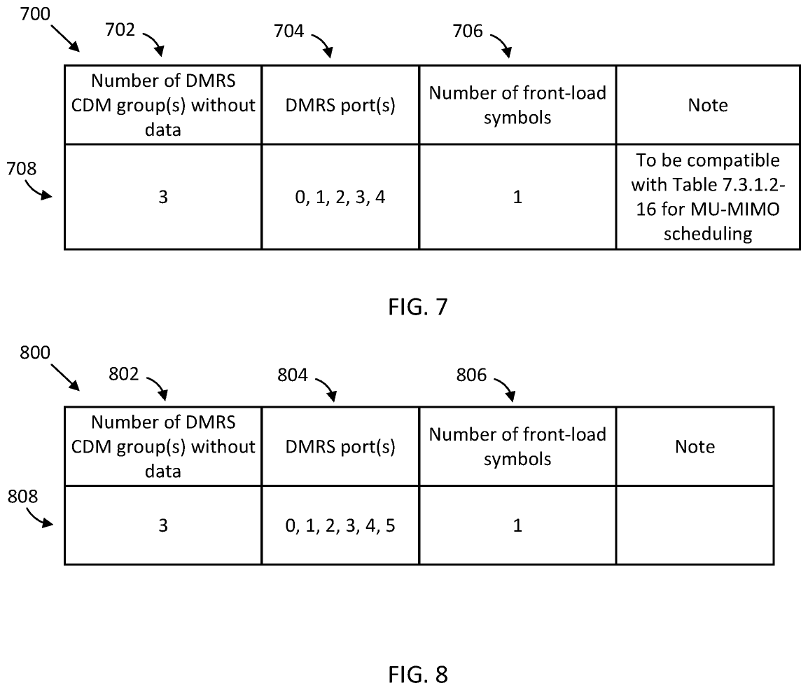

FIG. 7 illustrates an example table 700 for approach 2.2 in accordance with some embodiments. For example, the table 700 may indicate antenna ports (which may be referred to as DMRS ports) that can be used for DMRS configuration type 2 PUSCH transmissions with a one symbol per DMRS location and a rank of five. The table 700 may be utilized to indicate antenna ports to be utilized for a PUSCH transmission to be transmitted by a UE. The table 700 may be stored by a base station and/or a UE and indications may be exchanged between the base station and the UE that refers to the table 700.

The table 700 may include one option for antenna ports to be utilized for PUSCH transmissions. The option may be defined based on a number of DMRS CDM groups without data 702, antenna ports 704 to be available for transmission, and number of front-load symbols 706.

As can be seen from the table 700, the option 708 may be for PUSCH transmissions with a number of DMRS CDM groups without data 702 equal to three and a number of front-load symbols 706 equal to one. The available antenna ports 704 for the option 708 may be port 0, port 1, port 2, port 3, and port 4. Accordingly, a base station may indicate that a UE is to utilize port 0, port 1, port 2, port 3, and port 4 for a PUSCH transmission by indicating the option 708 of the table 700.

The options shown in the table 700 may be compatible with options in a legacy table corresponding to a rank of three. For example, the options in the table 700 may indicate different antenna ports for transmission than corresponding options in the legacy table corresponding to a rank of three. Therefore, in MU-MIMO, a base station may indicate antenna ports to be utilized by a first UE using the table 700 and indicate antenna ports to be utilized by a second UE using the legacy table corresponding to a rank of three, where the antenna ports to be utilized by the first UE is different from the antenna ports to be utilized by the second UE. Based on the indications, the first UE and the second UE may transmit PUSCH transmissions using different antenna ports. The options in the table 700 may be compatible with legacy table 7.3.1.2-16 of TS 38.212 for MU-MIMO scheduling.

Approach 2.3: For legacy DMRS, DMRS configuration Type 2 (dmrs-Type=2) and maximum 1 symbol per DMRS location, for rank=6, the following table can be considered. For example, approach 2.3 may be for DMRS configuration type 2 with a maximum of one symbol per DMRS location and a rank of six for a PUSCH transmission.

FIG. 8 illustrates an example table 800 for approach 2.3 in accordance with some embodiments. For example, the table 800 may indicate antenna ports (which may be referred to as DMRS ports) that can be used for DMRS configuration type 2 PUSCH transmissions with a one symbol per DMRS location and a rank of six. The table 800 may be utilized to indicate antenna ports to be utilized for a PUSCH transmission to be transmitted by a UE. The table 800 may be stored by a base station and/or a UE and indications may be exchanged between the base station and the UE that refers to the table 800.

The table 800 may include one option for antenna ports to be utilized for PUSCH transmissions. The option may be defined based on a number of DMRS CDM groups without data 802, antenna ports 804 to be available for transmission, and number of front-load symbols 806.

As can be seen from the table 800, the option 808 may be for PUSCH transmissions with a number of DMRS CDM groups without data 802 equal to three and a number of front-load symbols 806 equal to one. The available antenna ports 804 for the option 708 may be port 0, port 1, port 2, port 3, port 4, and port 5. Accordingly, a base station may indicate that a UE is to utilize port 0, port 1, port 2, port 3, port 4, and port 5 for a PUSCH transmission by indicating the option 808 of the table 800.

Proposal 3: Legacy DMRS, dmrs-Type=2, maxLength=2

Approach 3.1: For legacy DMRS, DMRS configuration Type 2 (dmrs-Type=2) and maximum 2 symbols per DMRS location, to support more than 4 layer PUSCH, the following are the possible combinations. (3 CDM groups, 1 symbol DMRS): maximum #DMRS ports=6. (2 CDM groups, 2 symbol DMRS): maximum #DMRS ports=8. (3 CDM groups, 2 symbol DMRS): maximum #DMRS ports=12. For example, approach 3.1 may apply to DMRS configuration type 2 and a maximum two symbols per DMRS location. For approach 3.1, different combinations of numbers of CDM groups without data and front-load symbols may be supported. For example, a combination of three CDM groups and one symbol DMRS may be supported and may have a maximum of six DMRS ports. A combination of two CDM groups and two symbol DMRS may be supported and may have a maximum of eight DMRS ports. A combination of three CDM groups and two symbol DMRS may be supported and may have a maximum of twelve DMRS ports.

Approach 3.2: For legacy DMRS, DMRS configuration Type 2 (dmrs-Type=2) and maximum 2 symbols per DMRS location, for rank=5, one or multiple of rows of the following table can be considered. For example, the approach 3.2 may apply to DMRS configuration type 2 and a maximum two symbols per DMRS location associated with a PUSCH transmission. For approach 3.2, the rank of five may be associated with the PUSCH transmission.

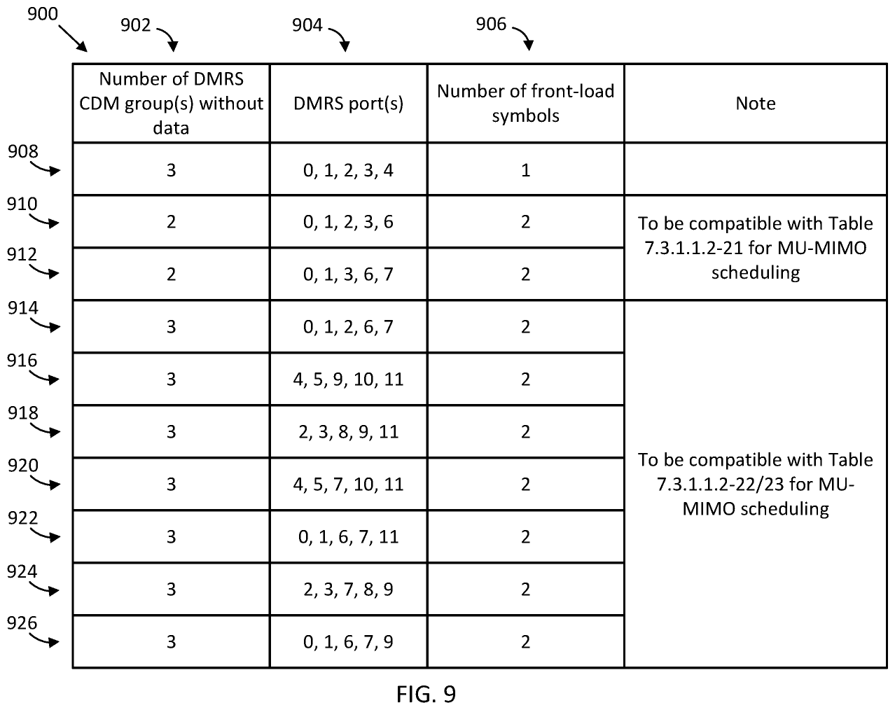

FIG. 9 illustrates an example table 900 for approach 3.2 in accordance with some embodiments. For example, the table 900 may indicate antenna ports (which may be referred to as DMRS ports) that can be used for DMRS configuration type 2 PUSCH transmissions with a maximum of two symbols per DMRS location and a rank of five. The table 900 may be utilized to indicate antenna ports to be utilized for a PUSCH transmission to be transmitted by a UE. The table 900 may be stored by a base station and/or a UE and indications may be exchanged between the base station and the UE that refers to the table 900.

The table 900 may include ten options for antenna ports to be utilized for PUSCH transmissions. The options may be defined based on a number of DMRS CDM groups without data 902, antenna ports 904 to be available for transmission, and number of front-load symbols 906.

As can be seen from the table 900, a first option 908 may be for PUSCH transmissions with a number of DMRS CDM groups without data 902 equal to three and a number of front-load symbols 906 equal to one. The available antenna ports 904 for the first option 908 may be port 0, port 1, port 2, port 3, and port 4. Accordingly, a base station may indicate that a UE is to utilize port 0, port 1, port 2, port 3, and port 4 for a PUSCH transmission by indicating the first option 908 of the table 900.

A second option 910 may be for PUSCH transmissions with a number of DMRS CDM groups without data 902 equal to two and a number of front-load symbols 906 equal to two. The available antenna ports 904 for the second option 910 may be port 0, port 1, port 2, port 3, and port 6. Accordingly, a base station may indicate that a UE is to utilize port 0, port 1, port 2, port 3, and port 6 for a PUSCH transmission by indicating the second option 910 of the table 900.

A third option 912 may be for PUSCH transmissions with a number of DMRS CDM groups without data 902 equal to two and a number of front-load symbols 906 equal to two. The available antenna ports 904 for the third option 912 may be port 0, port 1, port 3, port 6, and port 7. Accordingly, a base station may indicate that a UE is to utilize port 0, port 1, port 3, port 6, and port 7 for a PUSCH transmission by indicating the third option 912 of the table 900.

A fourth option 914 may be for PUSCH transmissions with a number of DMRS CDM groups without data 902 equal to three and a number of front-load symbols 906 equal to two. The available antenna ports 904 for the fourth option 914 may be port 0, port 1, port 2, port 6, and port 7. Accordingly, a base station may indicate that a UE is to utilize port 0, port 1, port 2, port 6, and port 7 for a PUSCH transmission by indicating the fourth option 914 of the table 900.

A fifth option 916 may be for PUSCH transmissions with a number of DMRS CDM groups without data 902 equal to three and a number of front-load symbols 906 equal to two. The available antenna ports 904 for the fifth option 916 may be port 4, port 5, port 9, port 10, and port 11. Accordingly, a base station may indicate that a UE is to utilize port 4, port 5, port 9, port 10, and port 11 for a PUSCH transmission by indicating the fifth option 916 of the table 900.

A sixth option 918 may be for PUSCH transmissions with a number of DMRS CDM groups without data 902 equal to three and a number of front-load symbols 906 equal to two. The available antenna ports 904 for the sixth option 918 may be port 2, port 3, port 8, port 9, and port 11. Accordingly, a base station may indicate that a UE is to utilize port 2, port 3, port 8, port 9, and port 11 for a PUSCH transmission by indicating the sixth option 918 of the table 900.

A seventh option 920 may be for PUSCH transmissions with a number of DMRS CDM groups without data 902 equal to three and a number of front-load symbols 906 equal to two. The available antenna ports 904 for the seventh option 920 may be port 4, port 5, port 7, port 10, and port 11. Accordingly, a base station may indicate that a UE is to utilize port 4, port 5, port 7, port 10, and port 11 for a PUSCH transmission by indicating the seventh option 920 of the table 900.

An eighth option 922 may be for PUSCH transmissions with a number of DMRS CDM groups without data 902 equal to three and a number of front-load symbols 906 equal to two. The available antenna ports 904 for the eighth option 922 may be port 0, port 1, port 6, port 7, and port 11. Accordingly, a base station may indicate that a UE is to utilize port 0, port 1, port 6, port 7, and port 11 for a PUSCH transmission by indicating the eighth option 922 of the table 900.

A ninth option 924 may be for PUSCH transmissions with a number of DMRS CDM groups without data 902 equal to three and a number of front-load symbols 906 equal to two. The available antenna ports 904 for the ninth option 924 may be port 2, port 3, port 7, port 8, and port 9. Accordingly, a base station may indicate that a UE is to utilize port 2, port 3, port 7, port 8, and port 9 for a PUSCH transmission by indicating the ninth option 924 of the table 900.

A tenth option 926 may be for PUSCH transmissions with a number of DMRS CDM groups without data 902 equal to three and a number of front-load symbols 906 equal to two. The available antenna ports 904 for the tenth option 926 may be port 0, 1, port 6, port 7, and port 9. Accordingly, a base station may indicate that a UE is to utilize port 0, 1, port 6, port 7, and port 9 for a PUSCH transmission by indicating the tenth option 926 of the table 900.

The options shown in the table 900 may be compatible with options in legacy tables. For example, the options in the table 900 may indicate different antenna ports for transmission than corresponding options in corresponding legacy tables. Therefore, in MU-MIMO, a base station may indicate antenna ports to be utilized by a first UE using the table 900 and indicate antenna ports to be utilized by a second UE using the corresponding legacy tables, where the antenna ports to be utilized by the first UE is different from the antenna ports to be utilized by the second UE. Based on the indications, the first UE and the second UE may transmit PUSCH transmissions using different antenna ports. The second option 910 and the third option 912 of the table 900 may be compatible with legacy table 7.3.1.1.2-21 of TS 38.212 for MU-MIMO scheduling. The fourth option 914, the fifth option 916, the sixth option 918, the seventh option 920, the eighth option 922, the ninth option 924, and the tenth option 926 of the table 900 may be compatible with legacy table 7.3.1.1.2-22/23 of TS 38.212 for MU-MEVIO scheduling.

Approach 3.3: For legacy DMRS, DMRS configuration Type 2 (dmrs-Type=2) and maximum 2 symbols per DMRS location, for rank=6, one or multiple of rows of the following table can be considered. For example, the approach 3.3 may apply to DMRS configuration type 2 and a maximum of two symbols per DMRS location associated with a PUSCH transmission. For approach 3.3, the rank of six may be associated with the PUSCH transmission.

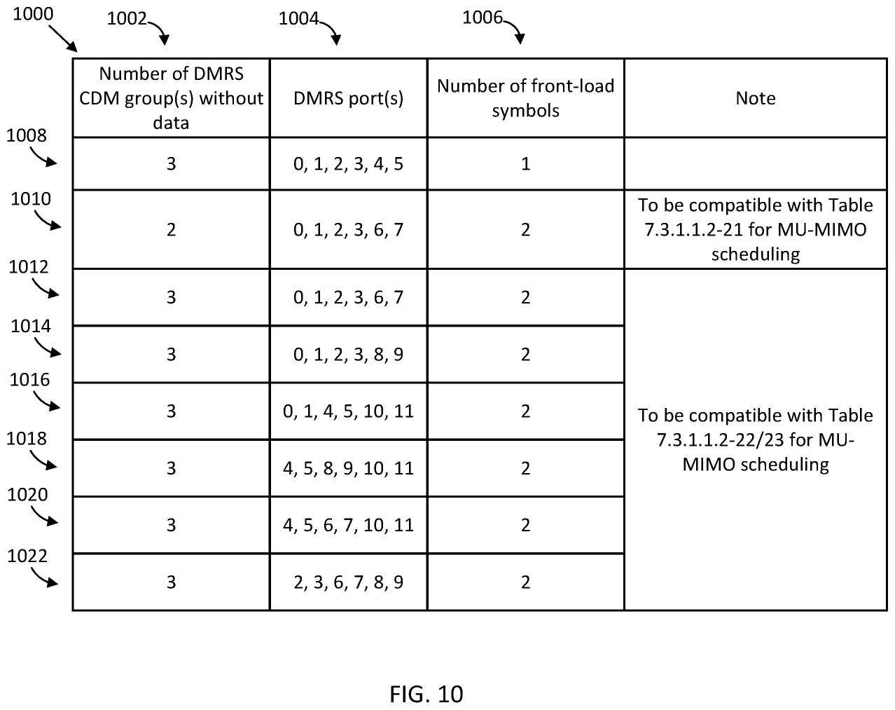

FIG. 10 illustrates an example table 1000 for approach 3.3 in accordance with some embodiments. For example, the table 1000 may indicate antenna ports (which may be referred to as DMRS ports) that can be used for DMRS configuration type 2 PUSCH transmissions with a maximum of two symbols per DMRS location and a rank of six. The table 1000 may be utilized to indicate antenna ports to be utilized for a PUSCH transmission to be transmitted by a UE. The table 1000 may be stored by a base station and/or a UE and indications may be exchanged between the base station and the UE that refers to the table 1000.

The table 1000 may include eight options for antenna ports to be utilized for PUSCH transmissions. The options may be defined based on a number of DMRS CDM groups without data 1002, antenna ports 1004 to be available for transmission, and number of front-load symbols 1006.

As can be seen from the table 1000, a first option 1008 may be for PUSCH transmissions with a number of DMRS CDM groups without data 1002 equal to three and a number of front-load symbols 1006 equal to one. The available antenna ports 1004 for the first option 1008 may be port 0, port 1, port 2, port 3, port 4, and port 5. Accordingly, a base station may indicate that a UE is to utilize port 0, port 1, port 2, port 3, port 4, and port 5 for a PUSCH transmission by indicating the first option 1008 of the table 1000.

A second option 1010 may be for PUSCH transmissions with a number of DMRS CDM groups without data 1002 equal to two and a number of front-load symbols 1006 equal to two. The available antenna ports 1004 for the second option 1010 may be port 0, port 1, port 2, port 3, port 6, and port 7. Accordingly, a base station may indicate that a UE is to utilize port 0, port 1, port 2, port 3, port 6, and port 7 for a PUSCH transmission by indicating the second option 1010 of the table 1000.

A third option 1012 may be for PUSCH transmissions with a number of DMRS CDM groups without data 1002 equal to three and a number of front-load symbols 1006 equal to two. The available antenna ports 1004 for the third option 1012 may be port 0, port 1, port 2, port 3, port 6, and port 7. Accordingly, a base station may indicate that a UE is to utilize port 0, port 1, port 2, port 3, port 6, and port 7 for a PUSCH transmission by indicating the third option 1012 of the table 1000.

A fourth option 1014 may be for PUSCH transmissions with a number of DMRS CDM groups without data 1002 equal to three and a number of front-load symbols 1006 equal to two. The available antenna ports 1004 for the fourth option 1014 may be port 0, port 1, port 2, port 3, port 8, and port 9. Accordingly, a base station may indicate that a UE is to utilize port 0, port 1, port 2, port 3, port 8, and port 9 for a PUSCH transmission by indicating the fourth option 1014 of the table 1000.

A fifth option 1016 may be for PUSCH transmissions with a number of DMRS CDM groups without data 1002 equal to three and a number of front-load symbols 1006 equal to two. The available antenna ports 1004 for the fifth option 1016 may be port 0, port, 1, port 4, port 5, port 10, and port 11. Accordingly, a base station may indicate that a UE is to utilize port 0, port, 1, port 4, port 5, port 10, and port 11 for a PUSCH transmission by indicating the fifth option 1016 of the table 1000.

A sixth option 1018 may be for PUSCH transmissions with a number of DMRS CDM groups without data 1002 equal to three and a number of front-load symbols 1006 equal to two. The available antenna ports 1004 for the sixth option 1018 may be port 4, port 5, port 8, port 9, port 10, and port 11. Accordingly, a base station may indicate that a UE is to utilize port 4, port 5, port 8, port 9, port 10, and port 11 for a PUSCH transmission by indicating the sixth option 1018 of the table 1000.

A seventh option 1020 may be for PUSCH transmissions with a number of DMRS CDM groups without data 1002 equal to three and a number of front-load symbols 1006 equal to two. The available antenna ports 1004 for the seventh option 1020 may be port 4, port 5, port 6, port 7, port 10, and port 11. Accordingly, a base station may indicate that a UE is to utilize port 4, port 5, port 6, port 7, port 10, and port 11 for a PUSCH transmission by indicating the seventh option 1020 of the table 1000.

An eighth option 1022 may be for PUSCH transmissions with a number of DMRS CDM groups without data 1002 equal to three and a number of front-load symbols 1006 equal to two. The available antenna ports 1004 for the eighth option 1022 may be port 2, port 3, port 6, port 7, port 8, and port 9. Accordingly, a base station may indicate that a UE is to utilize port 2, port 3, port 6, port 7, port 8, and port 9 for a PUSCH transmission by indicating the eighth option 1022 of the table 1000.

The options shown in the table 1000 may be compatible with options in legacy tables. For example, the options in the table 1000 may indicate different antenna ports for transmission than corresponding options in corresponding legacy tables. Therefore, in MU-MIMO, a base station may indicate antenna ports to be utilized by a first UE using the table 1000 and indicate antenna ports to be utilized by a second UE using the corresponding legacy tables, where the antenna ports to be utilized by the first UE is different from the antenna ports to be utilized by the second UE. Based on the indications, the first UE and the second UE may transmit PUSCH transmissions using different antenna ports. The second option 1010 of the table 1000 may be compatible with legacy table 7.3.1.1.2-21 of TS 38.212 for MU-MIMO scheduling. The third option 1012, the fourth option 1014, the fifth option 1016, the sixth option 1018, the seventh option 1020, and the eighth option 1022 of the table 1000 may be compatible with legacy table 7.3.1.1.2-22/23 of TS 38.212 for MU-MEVIO scheduling.

Approach 3.5: For legacy DMRS, DMRS configuration Type 2 (dmrs-Type=2) and maximum 2 symbols per DMRS location, for rank=7, one or multiple of rows of the following table can be considered. For example, the approach 3.5 may apply to DMRS configuration type 2 and a maximum of two symbols per DMRS location associated with a PUSCH transmission. For approach 3.5, the rank of seven may be associated with the PUSCH transmission.

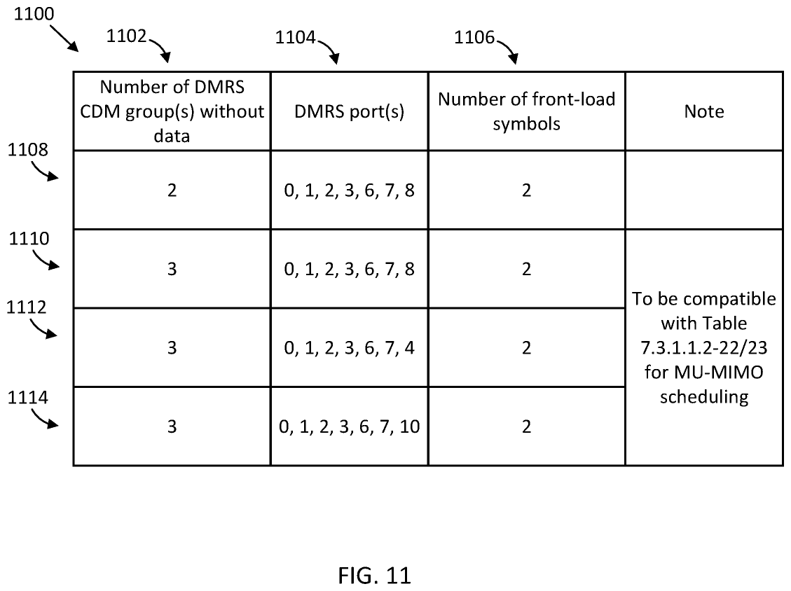

FIG. 11 illustrates an example table 1100 for approach 3.5 in accordance with some embodiments. For example, the table 1100 may indicate antenna ports (which may be referred to as DMRS ports) that can be used for DMRS configuration type 2 PUSCH transmissions with a maximum of two symbols per DMRS location and a rank of six. The table 1100 may be utilized to indicate antenna ports to be utilized for a PUSCH transmission to be transmitted by a UE. The table 1100 may be stored by a base station and/or a UE and indications may be exchanged between the base station and the UE that refers to the table 1100.

The table 1100 may include four options for antenna ports to be utilized for PUSCH transmissions. The options may be defined based on a number of DMRS CDM groups without data 1102, antenna ports 1104 to be available for transmission, and number of front-load symbols 1106.

As can be seen from the table 1100, a first option 1108 may be for PUSCH transmissions with a number of DMRS CDM groups without data 1102 equal to two and a number of front-load symbols 1106 equal to two. The available antenna ports 1104 for the first option 1108 may be port 0, port 1, port 2, port 3, port 6, port 7, and port 8. Accordingly, a base station may indicate that a UE is to utilize port 0, port 1, port 2, port 3, port 6, port 7, and port 8 for a PUSCH transmission by indicating the first option 1108 of the table 1100.

A second option 1110 may be for PUSCH transmissions with a number of DMRS CDM groups without data 1102 equal to three and a number of front-load symbols 1106 equal to two. The available antenna ports 1104 for the second option 1110 may be port 0, port 1, port 2, port 3, port 6, port 7, and port 8. Accordingly, a base station may indicate that a UE is to utilize port 0, port 1, port 2, port 3, port 6, port 7, and port 8 for a PUSCH transmission by indicating the second option 1110 of the table 1100.

A third option 1112 may be for PUSCH transmissions with a number of DMRS CDM groups without data 1102 equal to three and a number of front-load symbols 1106 equal to two. The available antenna ports 1104 for the third option 1112 may be port 0, port 1, port 2, port 3, port 4, port 6, and port 7. Accordingly, a base station may indicate that a UE is to utilize port 0, port 1, port 2, port 3, port 4, port 6, and port 7 for a PUSCH transmission by indicating the third option 1112 of the table 1100.

A fourth option 1114 may be for PUSCH transmissions with a number of DMRS CDM groups without data 1102 equal to three and a number of front-load symbols 1106 equal to two. The available antenna ports 1104 for the fourth option 1114 may be port 0, port 1, port 2, port 3, port 6, port 7, and port 10. Accordingly, a base station may indicate that a UE is to utilize port 0, port 1, port 2, port 3, port 6, port 7, and port 10 for a PUSCH transmission by indicating the fourth option 1114 of the table 1100.

The options shown in the table 1100 may be compatible with options in legacy tables. For example, the options in the table 1100 may indicate different antenna ports for transmission than corresponding options in corresponding legacy tables. Therefore, in MU-MIMO, a base station may indicate antenna ports to be utilized by a first UE using the table 1100 and indicate antenna ports to be utilized by a second UE using the corresponding legacy tables, where the antenna ports to be utilized by the first UE is different from the antenna ports to be utilized by the second UE. Based on the indications, the first UE and the second UE may transmit PUSCH transmissions using different antenna ports. The second option 1110, the third option 1112, and the fourth option 1114 of the table 1100 may be compatible with legacy table 7.3.1.1.2-22/23 of TS 38.212 for MU-MIMO scheduling.

Approach 3.6: For legacy DMRS, DMRS configuration Type 2 (dmrs-Type=2) and maximum 2 symbols per DMRS location, for rank=8, one or multiple of rows of the following table can be considered. For example, the approach 3.6 may apply to DMRS configuration type 2 and a maximum of two symbols per DMRS location associated with a PUSCH transmission. For approach 3.5, the rank of eight may be associated with the PUSCH transmission.

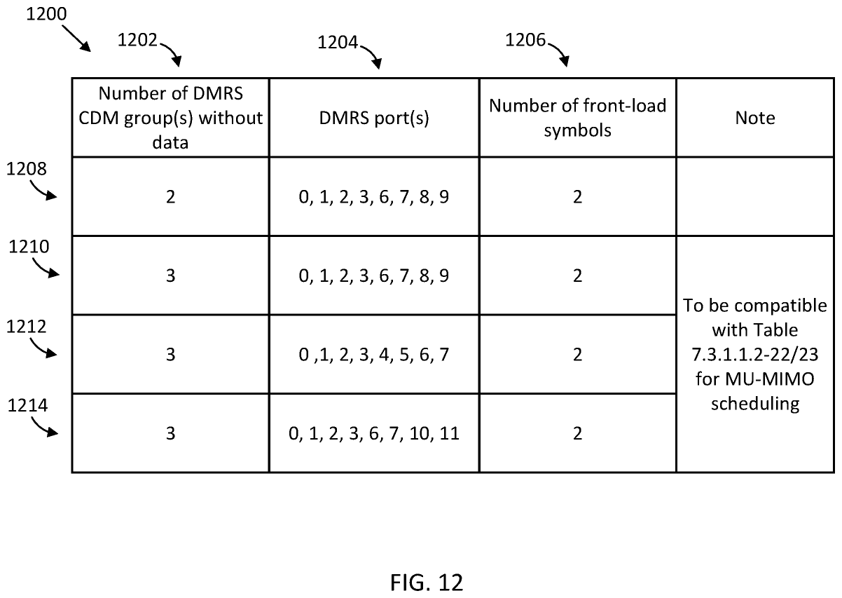

FIG. 12 illustrates an example table 1200 for approach 3.6 in accordance with some embodiments. For example, the table 1200 may indicate antenna ports (which may be referred to as DMRS ports) that can be used for DMRS configuration type 2 PUSCH transmissions with a maximum of two symbols per DMRS location and a rank of eight. The table 1200 may be utilized to indicate antenna ports to be utilized for a PUSCH transmission to be transmitted by a UE. The table 1200 may be stored by a base station and/or a UE and indications may be exchanged between the base station and the UE that refers to the table 1200.

The table 1200 may include four options for antenna ports to be utilized for PUSCH transmissions. The options may be defined based on a number of DMRS CDM groups without data 1202, antenna ports 1204 to be available for transmission, and number of front-load symbols 1206.

As can be seen from the table 1200, a first option 1208 may be for PUSCH transmissions with a number of DMRS CDM groups without data 1202 equal to two and a number of front-load symbols 1206 equal to two. The available antenna ports 1204 for the first option 1208 may be port 0, port 1, port 2, port 3, port 6, port 7, port 8, and port 9. Accordingly, a base station may indicate that a UE is to utilize port 0, port 1, port 2, port 3, port 6, port 7, port 8, and port 9 for a PUSCH transmission by indicating the first option 1208 of the table 1200.

A second option 1210 may be for PUSCH transmissions with a number of DMRS CDM groups without data 1202 equal to three and a number of front-load symbols 1206 equal to two. The available antenna ports 1204 for the second option 1210 may be port 0, port 1, port 2, port 3, port 6, port 7, port 8, and port 9. Accordingly, a base station may indicate that a UE is to utilize port 0, port 1, port 2, port 3, port 6, port 7, port 8, and port 9 for a PUSCH transmission by indicating the second option 1210 of the table 1200.

A third option 1212 may be for PUSCH transmissions with a number of DMRS CDM groups without data 1202 equal to three and a number of front-load symbols 1206 equal to two. The available antenna ports 1204 for the third option 1212 may be port 0, port 1, port 2, port 3, port 4, port 5, port 6, and port 7. Accordingly, a base station may indicate that a UE is to utilize port 0, port 1, port 2, port 3, port 4, port 5, port 6, and port 7 for a PUSCH transmission by indicating the third option 1212 of the table 1200.

A fourth option 1214 may be for PUSCH transmissions with a number of DMRS CDM groups without data 1202 equal to three and a number of front-load symbols 1206 equal to two. The available antenna ports 1204 for the fourth option 1214 may be port 0, port 1, port 2, port 3, port 6, port 7, port 10, and port 11. Accordingly, a base station may indicate that a UE is to utilize port 0, port 1, port 2, port 3, port 6, port 7, port 10, and port 11 for a PUSCH transmission by indicating the fourth option 1214 of the table 1200.

The options shown in the table 1200 may be compatible with options in legacy tables. For example, the options in the table 1200 may indicate different antenna ports for transmission than corresponding options in corresponding legacy tables. Therefore, in MU-MIMO, a base station may indicate antenna ports to be utilized by a first UE using the table 1200 and indicate antenna ports to be utilized by a second UE using the corresponding legacy tables, where the antenna ports to be utilized by the first UE is different from the antenna ports to be utilized by the second UE. Based on the indications, the first UE and the second UE may transmit PUSCH transmissions using different antenna ports. The second option 1210, the third option 1212, and the fourth option 1214 of the table 1200 may be compatible with legacy table 7.3.1.1.2-22/23 of TS 38.212 for MU-MIMO scheduling.

Proposal 4: General Design

Approach 4.1: Without introducing new antenna ports table, more than 1 “antenna port(s)” field can be indicated by next generation NodeB (gNB) to support up to 8 layer PUSCH operation. For example, one or more antenna port fields may be included in information elements utilized for indicating available antenna ports for PUSCH transmissions, where the antenna port fields indicate available antenna ports greater than four antenna ports. In some embodiments, the information element may include a field that indicates availability of a first four antenna ports of a set of antenna ports. The one or more additional antenna port fields may indicate the availability of the rest of the antenna ports of the set of antenna ports, where the rest of the antenna ports may be referred to as the greater than four antenna ports. By being able to indicate the availability of the greater than four antenna ports, the system may be able to support up to eight layer PUSCH operation.

All simultaneously indicated “antenna port(s)” fields have the following restrictions. They need to map to the same “Number of DMRS code division multiplex (CDM) group(s) without data.” They need to map to the same “Number of front-load symbols.” They need to map to unique DMRS port. For example, antenna port fields included in the information element in a transmission may map to a same number of DMRS CDM groups without data, may map to a same number of front-load symbols, may map to unique DMRS ports, or some combination thereof.

The different “antenna port(s)” fields that are simultaneously indicated may correspond to different or the same antenna ports table. For example, the antenna port fields may refer to legacy antenna port tables to indicate the available antenna ports for a PUSCH transmission. The antenna fields included in the information element in a transmission may all refer to a same antenna port table, may all refer to different antenna port tables, or some combination thereof. All the unique DMRS ports indicated by multiple “antenna port(s)” fields simultaneously are used for DMRS.

Approach 4.2: Without introducing new antenna ports table, complement of the “antenna port(s)” field can be indicated by gNB to support up to 8 layer PUSCH operation. For example, one or more antenna port fields within an information element may indicate the antenna ports that are unavailable and/or are not to be utilized for a PUSCH transmission. NW indicates the “antenna port(s)” field. For example, the NW, via a base station, may indicate the one or more antenna port fields to a UE, where the antenna port fields indicate the antenna ports that are unavailable and/or are not to be utilized for a PUSCH transmission. The DMRS ports that are not indicated by the “antenna port(s)” field are used for actual DMRS transmission. For example, the UE may be utilized the antenna ports that are not indicated as being unavailable or not to be utilized by the one or more antenna port fields to transmit a PUSCH transmission.

General procedure to determine antenna port indication for greater than 4 layer PUSCH. Given a number of DMRS symbols and DMRS type, for antenna port indication of y greater than 4 layers (ports), we look at the legacy antenna port table to identify the antenna ports that can be used for the x less than 4 layers (ports), then to facilitate the co-scheduling of MU-MIMO, y greater than 4 ports can be selected complement to the x less than 4 ports, i.e., using different ports. For example, approaches described herein may complement legacy antenna port tables. The legacy antenna port tables can be utilized for indicating less than four ports to be utilized for communications. The legacy tables may indicate the antenna ports available for instances where a UE is utilizing less than four antenna ports. The approaches described herein may indicate different antenna ports than indicated in the corresponding legacy table to be utilized by another UE with a PUSCH associated with more than four ports. For example, a legacy table may indicate three available antenna ports for a first UE for a transmission of a rank of three. An approach described herein may indicate a corresponding five available antenna ports for a second UE, where the five available antenna ports may different than the three available antenna ports indicated in the corresponding legacy table.

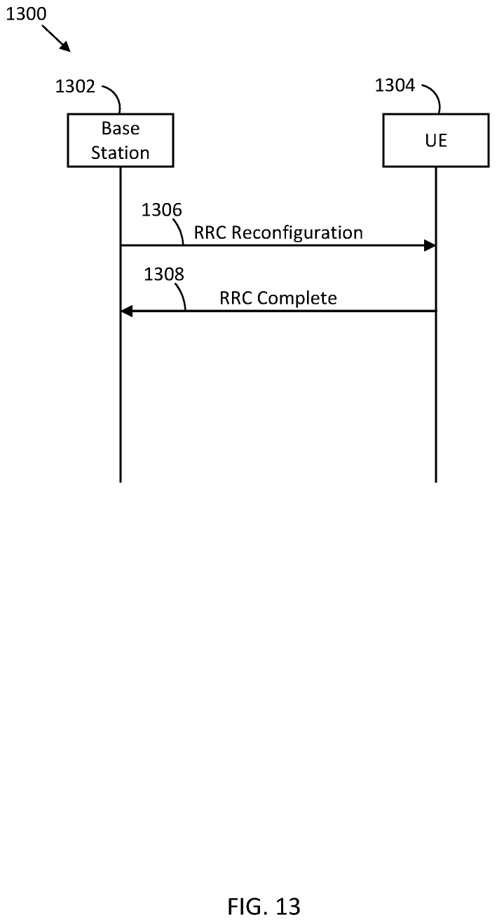

The approaches for indicating the available antenna ports and/or the unavailable/not to be utilized antenna ports described above may be implemented via one or more signaling procedures. For example, FIG. 13 illustrates an example signaling chart 1300 that can implement at least a portion of the one or more approaches in accordance with some embodiments.

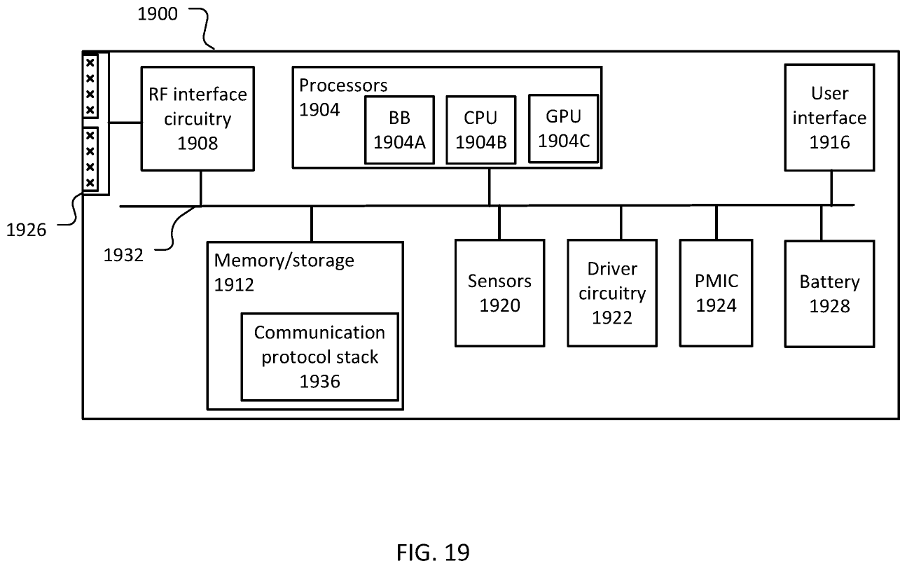

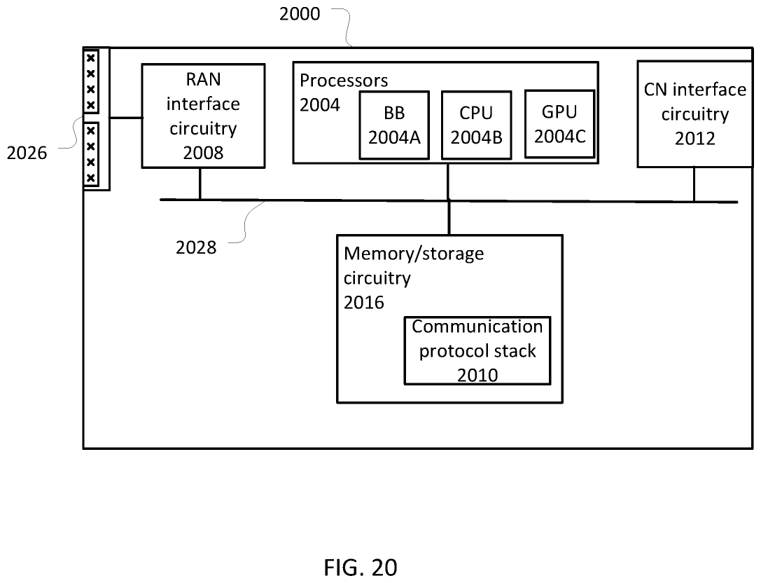

The signaling chart 1300 may indicate signals exchanged between a base station 1302 and a UE 1304. The base station 1302 may include one or more of the features of the gNB 2000 (FIG. 20). The UE 1304 may include one or more of the features of the UE 1900 (FIG. 19).

The signals exchanged between the base station 1302 and the UE 1304 may support indication of antenna ports for PUSCH transmissions by the UE 1304 for PUSCH transmissions of greater than four layers.

The signaling chart 1300 may include a configuration transmission, which is illustrated as an RRC reconfiguration transmission 1306 in the illustrated embodiment. The RRC reconfiguration transmission 1306 may include one or more of the fields described in relation to the approaches. The base station 1302 may transmit the RRC reconfiguration transmission 1306 to the UE 1304.

In some instances, the RRC reconfiguration transmission 1306 may include one or more of the tables described throughout this disclosure, such as the table 300 (FIG. 3), the table 400 (FIG. 4), the table 500 (FIG. 5), the table 600 (FIG. 6), the table 700 (FIG. 7), the table 800 (FIG. 8), the table 900 (FIG. 9), the table 1000 (FIG. 10), the table 1100 (FIG. 11), and/or the table 1200 (FIG. 12). In other instances, the RRC reconfiguration transmission 1306 may include an indication of more than four antenna ports that may be utilized by the UE 1304 for transmitting a PUSCH transmission. The indication of the antenna ports may indicate one option from the tables described throughout this disclosure, such as an option from the table 300, the table 400, the table 500, the table 600, the table 700, the table 800, the table 900, the table 1000, the table 1100, and/or the table 1200. In other instances, the indication of the antenna ports may include one or more fields of an information element that includes indications of available antenna ports or unavailable antenna ports.

Some embodiments may provide configuration information in an RRC configuration similar to that described in TS 38.331 ((3GPP Organizational Partners, “3rd Generation Partnership Project; Technical Specification Group Radio Access Network; NR; Radio Resource Control (RRC) protocol specification (Release 17),” TS 38.331 V17.1.0, June 2022). NW configures PUSCH in PUSCH-Config, including txConfig=“codebook” or “nonCodebook.” For example, a PUSCH-Config information element utilized for RRC configuration of a UE may a txConfig element that indicates whether a UE is to be configured for PUSCH codebook operation or PUSCH nonCodebook operation. maxRank INTEGER (1 . . . 4). For example, the maximum rank indicated for a PUSCH transmission by the RRC configuration may be indicated by an integer between 1 and 4. NW configures PUSCH DMRS in DMRS-UplinkConfig including dmrs-Type=“type1” or “type2.” For example, a DMRS-UplinkConfig information element within an RRC configuration may indicate a dmrs-Type of type 1 or dmrs-Type of type 2 to be utilized for a PUSCH transmission by a UE. maxLength=1 or 2. For example, the indication of the dmrs-Type may have a maximum length of 1 or 2.

The UE 1304 may identify the RRC reconfiguration transmission 1306 received from the base station 1302. In instances where the RRC reconfiguration transmission 1306 includes one or more tables, the UE 1304 may store the tables to be referred to later for indicating antenna ports to be utilized by the UE 1304 for one or more PUSCH transmissions to be transmitted to the base station 1302. In instances where the RRC reconfiguration transmission 1306 includes the indication of the antenna ports, the UE 1304 may determine the antenna ports to be utilized by the UE 1304 for one or more PUSCH transmissions to be transmitted to the base station 1302. The UE 1304 may transmit an RRC complete transmission 1308 to the base station 1302 to indicate that the UE 1304 has successfully stored the tables or determined the antenna ports to be utilized.

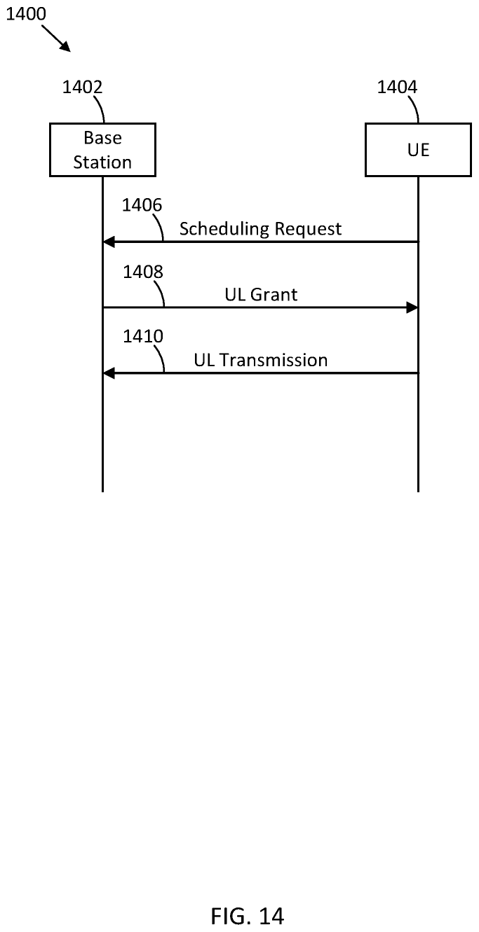

FIG. 14 illustrates an example signaling chart 1400 that can implement at least a portion of the one or more approaches in accordance with some embodiments. The signaling chart 1400 may indicate signals exchanged between a base station 1402 and a UE 1404. The base station 1402 may include one or more of the features of the gNB 2000 (FIG. 20). The UE 1404 may include one or more of the features of the UE 1900 (FIG. 19). The signals exchanged between the base station 1402 and the UE 1404 may support indication of antenna ports for PUSCH transmissions by the UE 1404 for PUSCH transmissions of greater than four layers.

The UE 1404 may transmit a scheduling request transmission 1406 to the base station 1402. The scheduling request transmission 1406 may indicate that the UE 1404 has a PUSCH transmission to transmit and request antenna ports on which the PUSCH transmission is to be transmitted. The scheduling request transmission 1406 may include information that the base station 1402 may utilize to determine the antenna ports to be utilized by the UE 1404 for the PUSCH transmission. For example, the scheduling request transmission 1406 may include an indication of a rank for the PUSCH transmission, a number of DMRS CDM groups without data associated with the UE 1404, a number of front-load symbols associated with the UE 1404, a DMRS configuration type associated with the UE 1404, a maximum length of DMRS symbols per DMRS location associated with the UE 1404, or some combination thereof.

The base station 1402 may receive the scheduling request transmission 1406 from the UE 1404. The base station 1402 may determine the antenna ports to be utilized by the UE 1404 for the PUSCH transmission. The base station 1402 may transmit a UL grant transmission 1408 to the UE 1404 that indicates the antenna ports to be utilized by the UE 1404 for the PUSCH transmission. The indication of the antenna ports may include an indication of a option of a table (such as an option of the table 300 (FIG. 3), the table 400 (FIG. 4), the table 500 (FIG. 5), the table 600 (FIG. 6), the table 700 (FIG. 7), the table 800 (FIG. 8), the table 900 (FIG. 9), the table 1000 (FIG. 10), the table 1100 (FIG. 11), and/or the table 1200 (FIG. 12)), one or more fields that indicate available antenna ports for transmission of the PUSCH transmission by the UE 1404, or one or more fields that indicate unavailable antenna ports for transmission of the PUSCH transmission by the UE 1404.

The UE 1404 may identify the UL grant transmission 1408 received from the base station 1402. The UE 1404 may determine the antenna ports to be utilized for the PUSCH transmission based on the indication of the antenna ports from the UL grant transmission 1408. The UE 1404 may transmit a UL transmission 1410 to the base station 1402 using the antenna ports indicated by the UL grant transmission 1408. The UL transmission 1410 may be a PUSCH transmission.

Some embodiments may provide uplink grant information in scheduling downlink control information (DCI) similar to that described in TS 38.212. In scheduling DCI, NW indicates the precoding matrix and number of layers using “SRS resource indicator” field in DCI for nonCodebook, “Precoding information and number of layers” field in DCI for Codebook. For example, the NW may transmit, via a base station, an indication in an SRS resource indicator field for nonCodebook or in a precoding information and number layers field for codebook of a DCI to indicate a precoding matrix and a number of layers for a UE. In scheduling DCI, NW indicates the DMRS ports used for DMRS transmission using “Antenna ports” field. For example, the NW may transmit, via a base station, an indication in an antenna ports field of DMRS ports to be utilized for DMRS transmission.

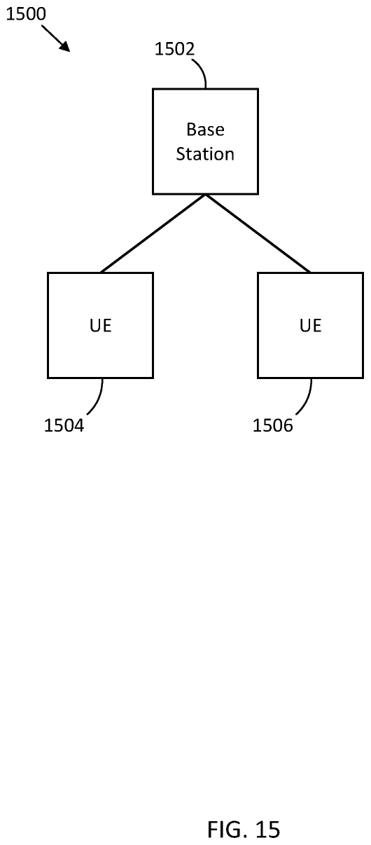

The approaches described throughout the disclosure may be utilized for MU-MIMO arrangements. For example, the approaches may be utilized for indicating antenna ports to be utilized by a UE for one or more PUSCH transmissions within a MU-MIMO arrangement. FIG. 15 illustrates a MU-MIMO arrangement 1500 in accordance with some embodiments. The MU-MIMO arrangement 1500 may implement one or more of the approaches described throughout the disclosure.

The MU-MIMO arrangement 1500 may include a base station 1502. The base station 1502 may include one or more of the features of the gNB 2000 (FIG. 20). The MU-MIMO arrangement 1500 may further include one or more UEs with connections to the base station 1502. The MU-MIMO arrangement 1500 includes a first UE 1504 and a second UE 1506 with connections to the base station 1502 in the illustrated embodiment.

The first UE 1504 may have a PUSCH transmission having a rank of greater than four to be transmitted. The second UE 1506 may have a PUSCH transmission having a rank of less than four to be transmitted. The base station 1502 may indicate antenna ports to be utilized by the first UE 1504 and the second UE 1506 for transmission of the PUSCH transmissions. The base station 1502 may indicate different antenna ports to be utilized for the PUSCH transmissions by the first UE 1504 and the second UE 1506. For example, the base station 1502 may utilize approaches described herein to indicate antenna ports to be utilized by the first UE 1504 for the PUSCH transmission, the antenna ports including more than four antenna ports. The base station 1502 may utilize one of the legacy tables to indicate antenna ports to be utilized by the second UE 1506 for the PUSCH transmission, the antenna ports including less than four antenna ports. The antenna ports indicated to the first UE 1504 may be different than the antenna ports indicated to the second UE 1506, such that none of the antenna ports indicated to the first UE 1504 are included in the antenna ports indicated to the second UE 1506. This may allow for the first UE 1504 to transmit PUSCH transmissions to the base station 1502 using a first portion of antenna ports of the base station 1502 while the second UE 1506 transmits PUSCH transmissions to the base station 1502 using a second portion of the antenna ports. In these instances, the first UE 1504 and the second UE 1506 may be capable of transmitting PUSCH transmissions to the base station 1502 at the same time.

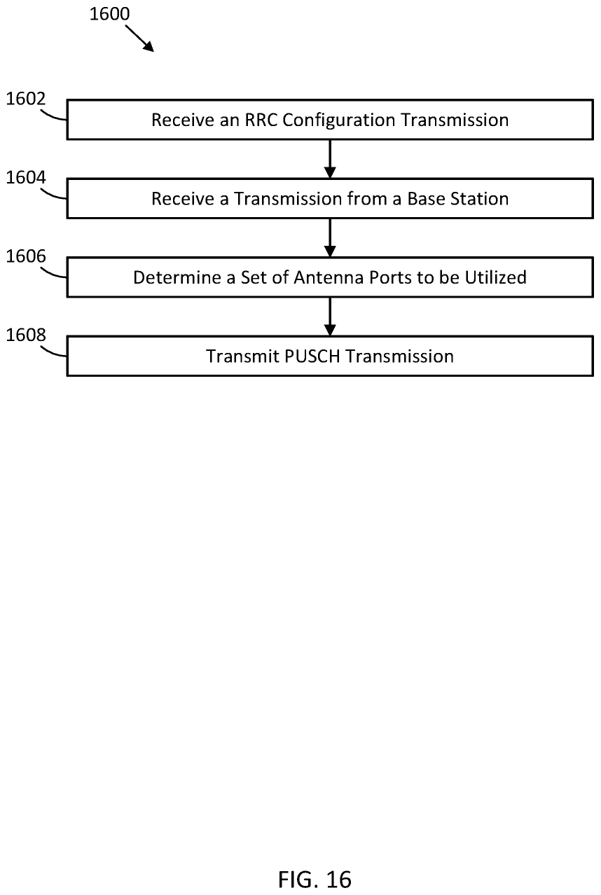

FIG. 16 illustrates an example procedure 1600 for operating a UE in accordance with some embodiments. The procedure 1600 may implement one or more of the approaches described throughout this disclosure, such as approaches for indicating antenna ports to be utilized by the UE for PUSCH transmission. The UE may include one or more of the features of the UE 1900 (FIG. 19).

The procedure 1600 may include receiving an RRC configuration transmission in 1602. For example, the UE may receive an RRC configuration transmission that indicates a table that indicates the one or more antenna ports for transmission of PUSCH transmissions. The table may comprise the table 300 (FIG. 3), the table 400 (FIG. 4), the table 500 (FIG. 5), the table 600 (FIG. 6), the table 700 (FIG. 7), the table 800 (FIG. 8), the table 900 (FIG. 9), the table 1000 (FIG. 10), the table 1100 (FIG. 11), and/or the table 1200 (FIG. 12). The RRC configuration transmission may include one or more of the features of the RRC reconfiguration transmission 1306 (FIG. 13) in some embodiments. In some embodiments, 1602 may be omitted.

The procedure 1600 may include receiving a transmission from the base station in 1604. For example, the UE may receive a transmission from the base station that indicates one or more antenna ports available for transmission of a PUSCH transmission of more than four layers. In some embodiments, the transmission indicates a number of antenna ports available equal to a number of layers for the PUSCH transmission. The transmission may include one or more of the features of the RRC reconfiguration transmission 1306 or the UL grant transmission 1408 (FIG. 14) in some embodiments.

In some embodiments, the one or more antenna ports may be based on a DMRS configuration type and a number of symbols per DMRS location associated with the UE. In some of these embodiments, the one or more antenna ports may be further based on a number of front-load symbols associated with the UE. In some of these embodiments, the one or more antenna ports are further based on a number of DMRS CDM groups without data associated with the UE.

In some embodiments, the transmission may include a first field that indicates an availability of a first group of antenna ports and a second field that indicates an availability of a second group of antenna ports. In some embodiments, the transmission from the base station comprises a DCI transmission.

In some embodiments, the transmission from the base station may indicate a number of antenna ports equal to the number of layers for the PUSCH transmission.

In embodiments where the RRC configuration transmission is received, the transmission from the base station may indicate the table to indicate the one or more antenna ports available for transmission for the PUSCH transmission.

In some embodiments, the UE may be a first UE and the set of antenna ports may be a first set of antenna ports. The second UE may be configured to utilize a second set of antenna ports for transmission. The first set of antenna ports and the second set of antenna ports include different antenna ports.

In some embodiments, the PUSCH transmission may be transmitted with a number of layers. The UE may be configured to transmit the PUSCH transmission with the number of layers. The transmission from the base station may indicate a number of antenna ports equal to the number of layers.

The procedure 1600 may include determining a set of antenna ports to be utilized in 1606. For example, the UE may determine, based on the one or more antenna ports indicated in the transmission, a set of antenna ports to be utilized for the PUSCH transmission. The set of antenna ports may include more than four antenna ports.

The procedure 1600 may include transmitting the PUSCH transmission in 1608. For example, the UE may transmit the PUSCH transmission to the base station utilizing the set of antenna ports.

While FIG. 16 may arguably indicate an order of operations of the procedure 1600, it should be understood that the operations may be performed in different orders in different embodiments. Further, it should be understood that one or more of the operations of the procedure 1600 may be performed concurrently in some embodiments. In some embodiments, the procedure 1600 may have one or more of the operations omitted and/or one or more additional operations added.

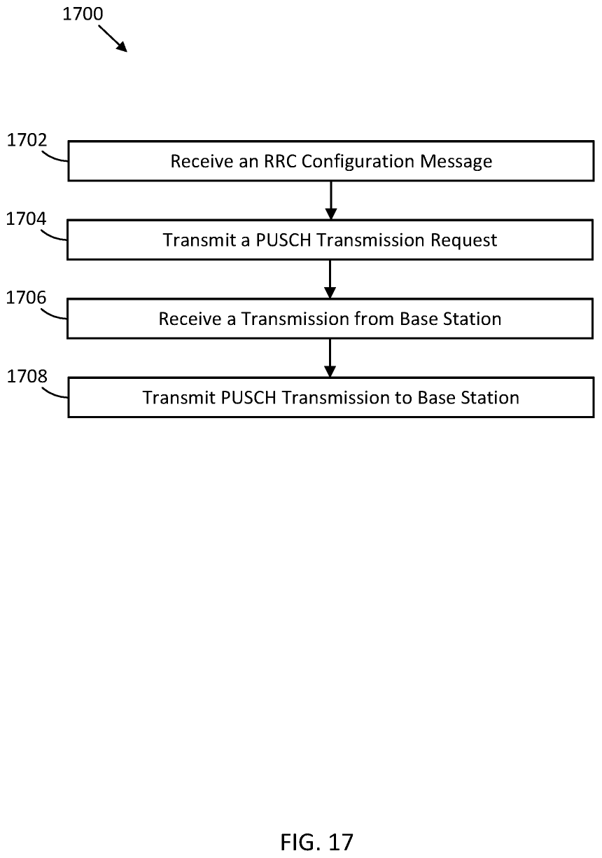

FIG. 17 illustrates an example procedure 1700 for operating a UE in accordance with some embodiments. The procedure 1700 may implement one or more of the approaches described throughout this disclosure, such as approaches for indicating antenna ports to be utilized by the UE for PUSCH transmission. The UE may include one or more of the features of the UE 1900 (FIG. 19).

The procedure 1700 may include receiving an RRC configuration message in 1702. For example, the UE may receive an RRC configuration message from the base station including a table that indicates the plurality of antenna ports. The RRC configuration message may include one or more of the features of the RRC reconfiguration transmission 1306 (FIG. 13) in some embodiments. In some embodiments, 1702 may be omitted.

The procedure 1700 may include transmitting a PUSCH transmission request in 1704. For example, the UE may transmit a PUSCH transmission request to a base station. The PUSCH transmission request may include one or more of the features of the scheduling request transmission 1406 (FIG. 14) in some embodiments. A PUSCH transmission corresponding to the PUSCH request may have a number of layers more than four in some embodiments.

The procedure 1700 may include receiving a transmission from the base station in 1706. For example, the UE may receive a transmission from the base station that indicates a plurality of antenna ports available for the PUSCH transmission. The plurality of antenna ports may include a number of antenna ports equal to or greater than the number of layers.

In some embodiments, the plurality of antenna ports may be selected based on a DMRS configuration type and a number of symbols per DMRS location associated with the UE. In some of these embodiments, the plurality of antennas ports may be selected based further on a number of front-load symbols associated with the UE. In some of these embodiments, the plurality of antenna ports may be selected based further on a number of DMRS CDM groups without data associated with the UE.

In some embodiments, the transmission may include a first field that indicates an availability of a first group of antenna ports and a second field that indicates an availability of a second group of the antenna ports. The plurality of antenna ports available may be indicated based on the first field and the second field.

In embodiments where the RRC configuration message is received, the transmission from the base station may indicate the table.

The procedure 1700 may include transmitting the PUSCH transmission to the base station in 1708. For example, the UE may transmit the PUSCH transmission to the base station via the plurality of antenna ports.

While FIG. 17 may arguably indicate an order of operations of the procedure 1700, it should be understood that the operations may be performed in different orders in different embodiments. Further, it should be understood that one or more of the operations of the procedure 1700 may be performed concurrently in some embodiments. In some embodiments, the procedure 1700 may have one or more of the operations omitted and/or one or more additional operations added.

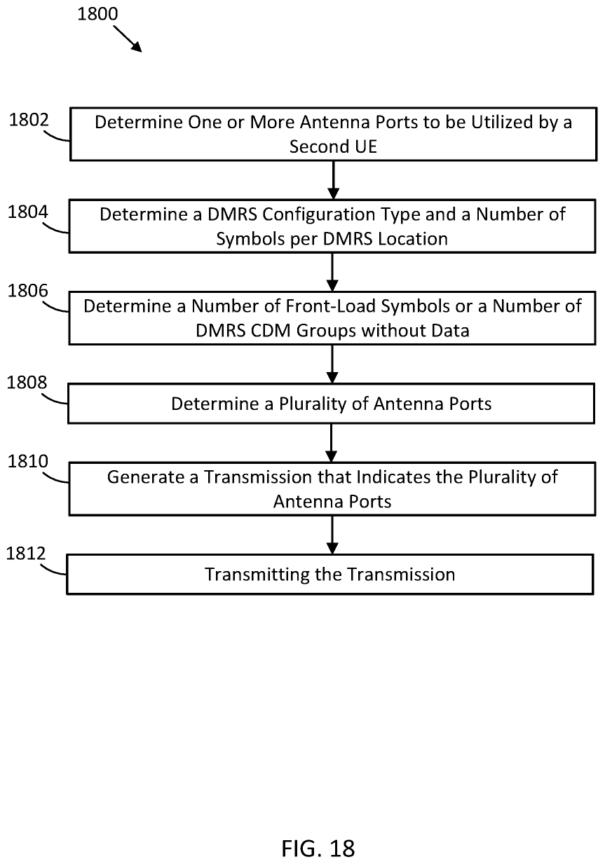

FIG. 18 illustrates an example procedure 1800 for operating a base station in accordance with some embodiments. The procedure 1800 may implement one or more of the approaches described throughout this disclosure, such as approaches for indicating, by the base station, antenna ports to be utilized by a UE for PUSCH transmission. The base station may include one or more of the features of the gNB 2000 (FIG. 20).

The procedure 1800 may include determining one or more antenna ports to be utilized by a second UE in 1802. For example, the base station may determine one or more antenna ports to be utilized by a second UE. The procedure 1800 may be performed to indicate antenna ports to be utilized by a UE, where the UE is a first UE. The second UE may be different than the first UE. In some embodiments, 1802 may be omitted.

The procedure 1800 may include determining a DMRS configuration type and a number of symbols per DMRS location in 1804. For example, the base station may determine a DMRS configuration type and a number of symbols per DMRS location associated with the UE. In some embodiments, 1804 may be omitted.

The procedure 1800 may include determining a number of front-load symbols or a number of DMRS CDM groups without data in 1806. For example, the base station may determine a number of front-load symbols associated with the UE or a number of DMRS CDM groups without data associated with the UE. In some embodiments, 1806 may be omitted.

The procedure 1800 may include determining a plurality of antenna ports in 1808. For example, the base station may determine, based on the number of layers, a plurality of antenna ports available for the PUSCH transmission. The base station may determine the plurality of antenna ports in preparation of receiving a PUSCH transmission with a number of layers from a UE in some embodiments, the number of layers being greater than four.

In embodiments where the DMRS configuration type and the number of symbols per DMRS location are determined, the plurality of antenna ports may be determined based further on the DMRS configuration type and the number of symbols per DMRS location associated with the UE.

In embodiments where the number of front-load symbols or the number of DMRS CDM groups are determined, the plurality of antenna ports may be determined based further on the number of front-load symbols associated with the UE or the number of DMRS CDM groups without data associated with the UE.

In embodiments where the one or more antenna ports to be utilized by the second UE is determined, the plurality of antenna ports may be determined based further on the one or more antenna ports to be utilized by the second UE.

The procedure 1800 may include generating a transmission that indicates the plurality of antenna ports in 1810. For example, the base station may generate a transmission that indicates the plurality of antenna ports.

The procedure 1800 may include transmitting the transmission in 1812. For example, the base station may transmit the transmission to the UE.

While FIG. 18 may arguably indicate an order of operations of the procedure 1800, it should be understood that the operations may be performed in different orders in different embodiments. Further, it should be understood that one or more of the operations of the procedure 1800 may be performed concurrently in some embodiments. In some embodiments, the procedure 1800 may have one or more of the operations omitted and/or one or more additional operations added.

FIG. 19 illustrates an example UE 1900 in accordance with some embodiments. The UE 1900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1900 may be a RedCap UE or NR-Light UE.

The UE 1900 may include processors 1904, RF interface circuitry 1908, memory/storage 1912, user interface 1916, sensors 1920, driver circuitry 1922, power management integrated circuit (PMIC) 1924, antenna structure 1926, and battery 1928. The components of the UE 1900 may be implemented as integrated circuits (ICs), portions thereof, discrete electronic devices, or other modules, logic, hardware, software, firmware, or a combination thereof. The block diagram of FIG. 19 is intended to show a high-level view of some of the components of the UE 1900. However, some of the components shown may be omitted, additional components may be present, and different arrangement of the components shown may occur in other implementations.

The components of the UE 1900 may be coupled with various other components over one or more interconnects 1932, which may represent any type of interface, input/output, bus (local, system, or expansion), transmission line, trace, optical connection, etc. that allows various circuit components (on common or different chips or chipsets) to interact with one another.

The processors 1904 may include processor circuitry such as, for example, baseband processor circuitry (BB) 1904A, central processor unit circuitry (CPU) 1904B, and graphics processor unit circuitry (GPU) 1904C. The processors 1904 may include any type of circuitry or processor circuitry that executes or otherwise operates computer-executable instructions, such as program code, software modules, or functional processes from memory/storage 1912 to cause the UE 1900 to perform operations as described herein.

In some embodiments, the baseband processor circuitry 1904A may access a communication protocol stack 1936 in the memory/storage 1912 to communicate over a 3GPP compatible network. In general, the baseband processor circuitry 1904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1908.

The baseband processor circuitry 1904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1912 may include one or more non-transitory, computer-readable media that includes instructions (for example, communication protocol stack 1936) that may be executed by one or more of the processors 1904 to cause the UE 1900 to perform various operations described herein. The memory/storage 1912 include any type of volatile or non-volatile memory that may be distributed throughout the UE 1900. In some embodiments, some of the memory/storage 1912 may be located on the processors 1904 themselves (for example, L1 and L2 cache), while other memory/storage 1912 is external to the processors 1904 but accessible thereto via a memory interface. The memory/storage 1912 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1908 may include transceiver circuitry and radio frequency front module (RFEM) that allows the UE 1900 to communicate with other devices over a radio access network. The RF interface circuitry 1908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1926 and proceed to filter and amplify (with a low-noise amplifier) the signal. The signal may be provided to a receiver of the transceiver that down-converts the RF signal into a baseband signal that is provided to the baseband processor of the processors 1904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1926.

In various embodiments, the RF interface circuitry 1908 may be configured to transmit/receive signals in a manner compatible with NR access technologies.

The antenna 1926 may include antenna elements to convert electrical signals into radio waves to travel through the air and to convert received radio waves into electrical signals. The antenna elements may be arranged into one or more antenna panels. The antenna 1926 may have antenna panels that are omnidirectional, directional, or a combination thereof to enable beamforming and multiple input, multiple output communications. The antenna 1926 may include microstrip antennas, printed antennas fabricated on the surface of one or more printed circuit boards, patch antennas, phased array antennas, etc. The antenna 1926 may have one or more panels designed for specific frequency bands including bands in FR1 or FR2.

The user interface circuitry 1916 includes various input/output (I/O) devices designed to enable user interaction with the UE 1900. The user interface 1916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1900.

The sensors 1920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1922 may include software and hardware elements that operate to control particular devices that are embedded in the UE 1900, attached to the UE 1900, or otherwise communicatively coupled with the UE 1900. The driver circuitry 1922 may include individual drivers allowing other components to interact with or control various input/output (I/O) devices that may be present within, or connected to, the UE 1900. For example, driver circuitry 1922 may include a display driver to control and allow access to a display device, a touchscreen driver to control and allow access to a touchscreen interface, sensor drivers to obtain sensor readings of sensor circuitry 1920 and control and allow access to sensor circuitry 1920, drivers to obtain actuator positions of electro-mechanic components or control and allow access to the electro-mechanic components, a camera driver to control and allow access to an embedded image capture device, audio drivers to control and allow access to one or more audio devices.

The PMIC 1924 may manage power provided to various components of the UE 1900. In particular, with respect to the processors 1904, the PMIC 1924 may control power-source selection, voltage scaling, battery charging, or DC-to-DC conversion.

In some embodiments, the PMIC 1924 may control, or otherwise be part of, various power saving mechanisms of the UE 1900. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1900 may power down for brief intervals of time and thus save power. If there is no data traffic activity for an extended period of time, then the UE 1900 may transition off to an RRC Idle state, where it disconnects from the network and does not perform operations such as channel quality feedback, handover, etc. The UE 1900 goes into a very low power state and it performs paging where again it periodically wakes up to listen to the network and then powers down again. The UE 1900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1928 may power the UE 1900, although in some examples the UE 1900 may be mounted deployed in a fixed location, and may have a power supply coupled to an electrical grid. The battery 1928 may be a lithium ion battery, a metal-air battery, such as a zinc-air battery, an aluminum-air battery, a lithium-air battery, and the like. In some implementations, such as in vehicle-based applications, the battery 1928 may be a typical lead-acid automotive battery.

FIG. 20 illustrates an example gNB 2000 in accordance with some embodiments. The gNB 2000 may include processors 2004, RF interface circuitry 2008, core network (CN) interface circuitry 2012, memory/storage circuitry 2016, and antenna structure 2026.

The components of the gNB 2000 may be coupled with various other components over one or more interconnects 2028.

The processors 2004, RF interface circuitry 2008, memory/storage circuitry 2016 (including communication protocol stack 2010), antenna structure 2026, and interconnects 2028 may be similar to like-named elements shown and described with respect to FIG. 19.

The CN interface circuitry 2012 may provide connectivity to a core network, for example, a 5th Generation Core network (5GC) using a 5GC-compatible network interface protocol such as carrier Ethernet protocols, or some other suitable protocol. Network connectivity may be provided to/from the gNB 2000 via a fiber optic or wireless backhaul. The CN interface circuitry 2012 may include one or more dedicated processors or FPGAs to communicate using one or more of the aforementioned protocols. In some implementations, the CN interface circuitry 2012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include one or more non-transitory computer-readable media having instructions that, when executed by one or more processors, cause a user equipment (UE) to receive a transmission from a base station that indicates one or more antenna ports available for transmission of a physical uplink shared channel (PUSCH) transmission of more than four layers, determine, based on the one or more antenna ports indicated in the transmission, a set of antenna ports to be utilized for the PUSCH transmission, the set of antenna ports including more than four antenna ports, and transmit the PUSCH transmission to the base station utilizing the set of antenna ports.

Example 2 may include the one or more non-transitory computer-readable media of example 1, wherein the transmission indicates a number of antenna ports available equal to a number of layers for the PUSCH transmission.

Example 3 may include the one or more non-transitory computer-readable media of example 1, wherein the PUSCH transmission is transmitted with a number of layers, and wherein the transmission from the base station indicates a number of antenna ports equal to the number of layers.

Example 4 may include the one or more non-transitory computer-readable media of example 1, wherein the one or more antenna ports are based on a demodulation reference signal (DMRS) configuration type and a number of symbols per DMRS location associated with the UE.

Example 5 may include the one or more non-transitory computer-readable media of example 4, wherein the one or more antenna ports are further based on a number of front-load symbols associated with the UE.

Example 6 may include the one or more non-transitory computer-readable media of example 4, wherein the one or more antenna ports are further based on a number of DMRS code division multiplexing (CDM) groups without data associated with the UE.

Example 7 may include the one or more non-transitory computer-readable media of example 1, wherein the transmission includes a first field that indicates an availability of a first group of antenna ports and a second field that indicates an availability of a second group of the antenna ports.

Example 8 may include the one or more non-transitory computer-readable media of example 1, wherein the UE is a first UE, wherein the set of antenna ports is a first set of antenna ports, wherein a second UE is configured to utilize a second set of antenna ports for transmission, and wherein the first set of antenna ports and the second set of antenna ports include different antenna ports.

Example 9 may include the one or more non-transitory computer-readable media of example 1, wherein the transmission from the base station comprises a downlink control information (DCI) transmission.

Example 10 may include the one or more non-transitory computer-readable media of example 1, wherein the instructions, when executed by the one or more processors, further cause the UE to receive a radio resource control (RRC) configuration transmission that indicates a table that indicates the one or more antenna ports for transmission of PUSCH transmissions, and wherein the transmission from the base station indicates the table to indicate the one or more antenna ports available for transmission of the PUSCH transmission.

Example 11 may include a user equipment (UE), comprising one or more antennas to provide for transmissions and one or more processors coupled to the one or more antennas, the one or more processors to transmit a physical uplink shared channel (PUSCH) transmission request to a base station, a PUSCH transmission corresponding to the PUSCH transmission request having a number of layers more than four, receive a transmission from the base station that indicates a plurality of antenna ports available for the PUSCH transmission, the plurality of antenna ports including a number of antenna ports equal to or greater than the number of layers, and transmit the PUSCH transmission to the base station via the plurality of antenna ports.

Example 12 may include the UE of example 11, wherein the plurality of antenna ports is selected based on a demodulation reference signal (DMRS) configuration type and a number of symbols per DMRS location associated with the UE.

Example 13 may include the UE of example 12, wherein the plurality of antenna ports is selected based further on a number of front-load symbols associated with the UE.

Example 14 may include the UE of example 12, wherein plurality of antenna ports is selected based further on a number of DMRS code division multiplexing (CDM) groups without data associated with the UE.

Example 15 may include the UE of example 11, wherein the transmission includes a first field that indicates an availability of a first group of antenna ports and a second field that indicates an availability of a second group of the antenna ports, wherein the plurality of antenna ports available is indicated based on the first field and the second field.

Example 16 may include the UE of example 11, wherein the one or more processors are further to receive a radio resource control (RRC) configuration message from the base station including a table that indicates the plurality of antenna ports, wherein the transmission from the base station indicates the table.

Example 17 may include a method of operating a base station, comprising in preparation of receiving a physical uplink shared channel (PUSCH) transmission with a number of layers from an a UE, the number of layers being greater than four: determining, based on the number of layers, a plurality of antenna ports available for the PUSCH transmission, generating a transmission that indicates the plurality of antenna ports, and transmitting the transmission to the UE.

Example 18 may include the method of example 17, further comprising determining a demodulation reference signal (DMRS) configuration type and a number of symbols per DMRS location associated with the UE, wherein the plurality of antenna ports is determined based further on the DMRS configuration type and the number of symbols per DMRS location associated with the UE.

Example 19 may include the method of example 18, further comprising determining a number of front-load symbols associated with the UE or a number of DMRS code division multiplexing (CDM) groups without data associated with the UE, wherein the plurality of antenna ports is determined based further on the number of front-load symbols associated with the UE or the number of DMRS CDM groups without data associated with the UE.

Example 20 may include the method of example 17, wherein the UE is a first UE, wherein the method further comprises determining one or more antenna ports to be utilized by a second UE, wherein the plurality of antenna ports is determined based further on the one or more antenna ports to be utilized by the second UE.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors, cause a user equipment (UE) to:
identify a physical uplink shared channel (PUSCH) transmission of more than four layers to be transmitted;
determine a set of antenna ports to be utilized for transmission of the PUSCH transmission, the set of antenna ports including more than four antenna ports; and
transmit the PUSCH transmission utilizing the set of antenna ports.

2. The one or more non-transitory computer-readable media of claim 1, wherein the set of antenna ports are determined based at least in part on a number of front-load symbols associated with the UE.

3. The one or more non-transitory computer-readable media of claim 1, wherein the set of antenna ports are determined based at least in part on a number of demodulation reference signal (DMRS) code division multiplexing (CDM) groups without data associated with the UE.

4. The one or more non-transitory computer-readable media of claim 1, wherein the UE is a first UE, wherein the set of antenna ports is a first set of antenna ports, wherein a second UE is configured to utilize a second set of antenna ports for transmission, and wherein the first set of antenna ports and the second set of antenna ports include different antenna ports.

5. The one or more non-transitory computer-readable media of claim 1, wherein the instructions, when executed by the one or more processors, cause the UE to:
receive a transmission from a base station that indicates one or more antenna ports available for transmission of the PUSCH transmission, wherein to determine the set of antenna ports includes to determine the set of antenna ports based at least in part on the one or more antenna ports indicated in the transmission.

6. The one or more non-transitory computer-readable media of claim 5, wherein the transmission indicates a number of antenna ports available equal to a number of layers for the PUSCH transmission.

7. The one or more non-transitory computer-readable media of claim 5, wherein the PUSCH transmission is transmitted with a number of layers, and wherein the transmission from the base station indicates a number of antenna ports equal to the number of layers.

8. The one or more non-transitory computer-readable media of claim 5, wherein the one or more antenna ports are based at least in part on a demodulation reference signal (DMRS) configuration type and a number of symbols per DMRS location associated with the UE.

9. The one or more non-transitory computer-readable media of claim 5, wherein the transmission includes a first field that indicates an availability of a first group of antenna ports and a second field that indicates an availability of a second group of the antenna ports.

10. The one or more non-transitory computer-readable media of claim 5, wherein the transmission from the base station comprises a downlink control information (DCI) transmission.

11. A user equipment (UE), comprising:
one or more antennas to provide for transmissions; and
one or more processors coupled to the one or more antennas, the one or more processors to:
transmit a physical uplink shared channel (PUSCH) transmission request to a base station, a PUSCH transmission corresponding to the PUSCH transmission request having a number of layers more than four;
receive a transmission from the base station that indicates a plurality of antenna ports available for the PUSCH transmission, the plurality of antenna ports including a number of antenna ports equal to or greater than the number of layers; and
transmit the PUSCH transmission to the base station via the plurality of antenna ports.

12. The UE of claim 11, wherein the plurality of antenna ports is selected based at least in part on a demodulation reference signal (DMRS) configuration type and a number of symbols per DMRS location associated with the UE.

13. The UE of claim 12, wherein the plurality of antenna ports is selected based at least in part on a number of front-load symbols associated with the UE.

14. The UE of claim 12, wherein plurality of antenna ports is selected based at least in part on a number of DMRS code division multiplexing (CDM) groups without data associated with the UE.

15. The UE of claim 11, wherein the transmission includes a first field that indicates an availability of a first group of antenna ports and a second field that indicates an availability of a second group of the antenna ports, wherein the plurality of antenna ports available is indicated based at least in part on the first field and the second field.

16. The UE of claim 11, wherein the one or more processors are further to:
receive a radio resource control (RRC) configuration message from the base station including a table that indicates the plurality of antenna ports, wherein the transmission from the base station indicates the table.

17. A method of operating a base station, comprising:
in preparation of receiving a physical uplink shared channel (PUSCH) transmission with a number of layers from a UE, the number of layers being greater than four:
determining, based at least in part on the number of layers, a plurality of antenna ports available for the PUSCH transmission;
generating a transmission that indicates the plurality of antenna ports; and
transmitting the transmission to the UE.

18. The method of claim 17, further comprising:
determining a demodulation reference signal (DMRS) configuration type and a number of symbols per DMRS location associated with the UE, wherein the plurality of antenna ports is determined based at least in part on the DMRS configuration type and the number of symbols per DMRS location associated with the UE.

19. The method of claim 18, further comprising:
determining a number of front-load symbols associated with the UE or a number of DMRS code division multiplexing (CDM) groups without data associated with the UE, wherein the plurality of antenna ports is determined based at least in part on the number of front-load symbols associated with the UE or the number of DMRS CDM groups without data associated with the UE.

20. The method of claim 17, wherein the UE is a first UE, wherein the method further comprises:
determining one or more antenna ports to be utilized by a second UE, wherein the plurality of antenna ports is determined based at least in part on the one or more antenna ports to be utilized by the second UE.
